(19) United States
(12) Patent Application Publication
(10) Pub. No.: US 2005/0080784 A1
(43) Pub. Date: Apr. 14, 2005

(54) Data processing system

(76) Inventors: Takashi Hashimoto, Fukuoka (JP); Yoichi Nishida, Kasuya-Gun (JP); Hiroto Tomita, Iizuka (JP); Masashi Hoshino, Iizuka (JP)

Correspondence Address: WENDEROTH, LIND & PONACK, L.L.P., 2033 K STREET N. W., SUITE 800, WASHINGTON, DC, 20006-1021, US

(21) Appl. No.: 10/611,937

(22) Filed: Jul. 3, 2003

(30) Foreign Application Priority Data
Jul. 11, 2002 (JP) 2002-202459

(51) Int. Cl. G06F 7/00

(52) U.S. Cl. 707/7

(57) ABSTRACT

This data processing system comprises a first data processing unit, performing processing of data under program control, a plurality of second data processing units, each performing processing of data under wired logic control, a storage unit storing the data, a first data transfer unit, connecting the first data processing unit and the second processing unit via the storage unit, and a second data transfer unit, connecting the plural second data processing units. Since the second data transfer unit, connecting the plural second data processing units operating under wired logic control are provided, the data transfer between a plurality of the second data processing units can be performed via the second data transfer unit. From the reason described above, the frequency of the data transfer via the first data transfer unit can be suppressed.

### BACKGROUND OF THE INVENTION

1. Field of the Invention

The present invention relates to a data processing system, comprising a data processing unit operable to execute data processing under program control and a plurality of data processing units operable to execute data processing under wed logic control.

2. Description of the Related Art

Recently, an importance of digital signal processing units, which can perform encoding and/or decoding for such as an MPEG (Moving Picture Experts Group) system or a JPEG (Joint Picture Experts Group) system, has been increased, as a result of rapid popularization of transmitting and receiving of digital video content via digital satellite broadcasting, internet, or portable information terminals.

Today, various coding systems exist in MPEG system, such an MPEG 1 system for use in recording media of CD-ROMs (compact disc-read only memories), for example, an MPEG 2 system for use in digital television broadcasting or recording media of DVDs (Digital Video Discs) and an MPEG4 system for use in a low bit rate system or a general purpose coding system.

In order to meet flexibly the various coding systems mentioned above, it is useful to deal with the various coding systems by means of software processing, operating on a common hardware, using general purpose processors or general purpose digital signal processors.

However, a high-performance general purpose processor or a general purpose digital signal processor may be required for the software processing, and the software processing needs much electric power, because an enormous amount of data needs to be processed in the data processing in the MPEG system or the JPEG system.

Since mobile terminal devices such as a cellular phone should work on batteries as a prerequisite, it is essential to realize their functional units having low electric power consumption.

In order to decrease an operating frequency, at which the functional units perform properly, a configuration using special purpose hardware with fixed function is often used.

With respect to the configuration using special purpose hardware, the reduction of electric power consumption is already realized by hardware configuration totally restricted to fixed functions operating at optimal frequency.

However, such countermeasure is not sufficient in terms of flexibility, since all processing is performed by hardware alone. In MPEG systems, for example, because a specification of each MPEG system is different each other, different kinds of hardware are needed to meet all specifications. When one MPEG system is operating, hardware corresponding to other MPEG systems does not work. As a result, wastefulness rises in the hardware.

In a software processing system a high-performance processor is required. A configuration comprising two parts is commonly employed today; one part consists of hardware for a fixed routine process that does not demand flexibility in processing, and the other part consists of software processing units for specification-dependent processes in the MPEG system. In other words, a system comprising both a data processing unit operable under program control and a special purpose hardware unit with fixed functions (a data processing unit with wired logic) is employed to solve the problem of performance, flexibility, and electric power consumption. Such a configuration does not necessitate a high-performance processor.

As a prior-art example, a data processing system, which comprises both a data processing unit based on program control and a data processing unit based on a special purpose hardware unit with fixed functions, will be explained by using a figure.

FIG. 9 shows a diagram of a prior-art data processing system. The prior-art data processing system comprises a main memory 300, a processor 301, a direct memory access controller (DMA controller) 302, a data bus 303, and a plurality of the special purpose function units A0˜An (n is an integer equal to or greater than unity), as shown in FIG. 9.

The processor 301 comprises a processing circuit 304 and a local data memory 305. The processor 301 is, for example, a general purpose processor or a general purpose digital signal processor.

The special purpose function units A0˜An comprise local data memories D0˜Dn and special purpose calculating circuits E0˜En.

The processor 301 corresponds to the data processing unit operating under program control, and each of the special purpose function units A0˜An corresponds to the data processing unit consisting of special purpose hardware with fixed function (data processing units operating under wired logic control).

The DMA controller 302 controls data transfer between the main memory 300 and the processor 301 or data transfer between the main memory 300 and the special purpose function units A0˜An.

The data bus 303 executes data transfer between the main memory 300 and processor 301 or data transfer between the main memory 300 and the special purpose function units A0˜An.

Next, the operation of a system as an example will be is described, using FIG. 9. First, a case that the special purpose function unit A0 processes the resultant data processed by the processor 301 is described.

The processor 301 executes under program control a series of instructions to transfer a part of data stored in the main data memory 300 to the local data memory 305 in the processor 301 and requests the DMA controller 302 to transfer the data.

When the data transfer between the processor 301 and the main data memory 300 or the data transfer between the main data memory 300 and the special purpose function units A0˜An are simultaneously requested, the DMA controller 302 arbitrates between these data transfer requests and the above-mentioned data transfer request. The DMA controller 302 finally accepts the abovementioned data transfer request and executes the data transfer from the main data memory 300 to the local data memory 305.

The calculating circuit 304 in the processor 301 executes a processing of data stored in the local memory unit 305, and then stores the result of processing into the local data memory 305.

Furthermore, the result of processing by the calculating circuit 304 stored in the local data memory 305, needs to be temporarily stored in the main memory 300.

The processor 301 executes a series of instructions to transfer the data stored in the local data memory 305 to the main memory 300, and requests the DMA controller 302 to transfer the data.

When another data transfer between the processor 301 and the main data memory 300 or any data transfer between the special purpose function units A0˜An and the main data memory 300 is simultaneously requested, the DMA controller 302 arbitrates between these data transfer requests and the above-mentioned data transfer request. The DMA controller 302 finally accepts the above-mentioned data transfer request, and executes the data transfer from the local data memory 305 to the main data memory 300.

The path of data transfer described above is a path from the main data memory 300, to the data bus 303, to the local data memory 305 in the processor 301, to the calculating circuit 304, to the local data memory 305, to the data bus 303, and to the main data memory 300, in this tun.

The processor 301 executes a series of instructions to transfer the above-mentioned data stored in the main data memory 300 to the local data memory DO in the special purpose function unit A0, and requests the DMA controller 302 to transfer the data.

When another data transfer between the processor 301 and the main data memory 300 or any data transfer between the special purpose function units A1˜An and the main data memory 300 is simultaneously requested, the DMA controller 302 arbitrates between these data transfer requests and the above-mentioned data transfer request. The DMA controller finally accepts the above-mentioned data transfer request, and executes the data transfer from the main data memory 300 to the local data memory D0.

The special purpose calculating circuit E0 in the special purpose function unit A0 executes a processing of the data stored in the local memory unit D0, and then stores the result of the processing in the local data memory D0.

Furthermore, the result of processing by the special purpose-processing circuit E0 stored in the local data memory D0 needs to be temporarily stored in the main memory 300.

The processor 301 executes a series of instructions to transfer the data stored in the local data memory D0 to the main memory 300, and requests the DMA controller 302 to transfer the data.

When another data transfer between the processor 301 and the main data memory 300 or the data transfer between the special purpose function units A1˜An and the main data memory 300 is simultaneously requested, the DMA controller 302 arbitrates between these data transfer requests and the above-mentioned data transfer request. The DMA controller 302 finally accepts the above-mentioned data transfer request and executes the data transfer from the local data memory D0 to the main data memory 300.

The path of data transfer described above is a path from the main data memory 300, to the data bus 303, to the local data memory D0 in the special purpose function unit A0, to the special purpose calculating circuit E0, to the local data memory D0, to the data bus 303, and to the main data memory 300, in this turn.

A data processing of the processor 301 for the result of data processing in the special purpose function unit A0 will be described.

The processor 301 executes, under program control, a series of instructions to transfer a part of data stored in the main data memory 300 to the local data memory D0 in the special purpose function unit A0, and requests the DMA controller 302 to transfer the data.

When another data transfer between the processor 301 and the local data memory 300 or the data transfer between the special purpose function units A1˜An and the local data memory 300 is simultaneously requested, the DMA controller 302 arbitrates between these data transfer requests and the above-mentioned data transfer request. The DMA controller 302 finally accepts the above-mentioned data transfer request, and executes the data transfer from the main data memory 300 to the local data memory D0.

The special purpose calculating circuit E0 in the special purpose function unit A0 executes a processing of the data stored in the local memory unit D0, and then stores the result of the processing in the local data memory D0.

The result of processing by the special purpose calculating circuit E0, stored in the local data memory D0, need to be temporarily stored in the main memory 300.

The processor 301 executes a series of instructions to transfer the data stored in the local data memory D0 to the main memory 300, and then requests the DMA controller 302 to transfer the data.

When another data transfer between the processor 301 and the local data memory 300 or the data transfer between the special purpose function units A1˜An and the local data memory 300 is simultaneously requested, the DMA controller 302 arbitrates between these data transfer requests and the above-mentioned data transfer request. The DMA controller 302 finally accepts the above-mentioned data transfer request, and executes the data transfer from the local data memory D0 to the main data memory 300.

The path of data transfer described above is a path from the main data memory 300, to the data bus 303, to the local data memory D0 in the special purpose function unit A0, to the special purpose calculating circuit E0, to the local data memory D0, to the data bus 303, and to the main data memory 300, in this turn.

The processor 301 executes a series of instructions to transfer the data stored in the main data memory 300 to the local memory unit 305 in the processor 301, and then requests the DMA controller 302 to transfer the data.

When another data transfer between the processor 301 and the local data memory 300 or the data transfer between the special purpose function units A0˜An and the local data memory 300 is simultaneously requested, the DMA controller 302 arbitrates between these data transfer requests and the above-mentioned data transfer request. The DMA controller 302 finally accepts the above-mentioned data transfer request, and executes the data transfer from the main data memory 300 to the local data memory 305.

The calculating circuit 304 in the processor 301 executes a processing of the data stored in the local data memory 305, and then stores the result of the processing in the local data memory 305.

The result of the processing by the processing circuit 304, stored in the local data memory 305, needs to be temporarily stored in the main memory 300.

The processor 301 executes a series of instructions to transfer the data stored in the local data memory 305 to the main memory 300, and then requests the DMA controller 302 to transfer the data.

When another data transfer between the processor 301 and the main data memory 300 or the data transfer between the special purpose function units A0˜An and the main data memory 300 is simultaneously requested, the DMA controller 302 arbitrates between these data transfer requests and the above-mentioned data transfer request. The DMA controller 302 finally accepts the above-mentioned data request, and executes the data transfer from the local data memory 305 to the main data memory 300.

The path of data transfer described above is a path from the main data memory 300, to the data bus 303, to the local data memory 305 in the processor 301, to the calculating circuit 304, to the local data memory 305, to the data bus 303, and to the main data memory 300, in this turn.

As described above, in the prior-art data processing system, the data transfer between the processor 301, which is a data processing unit based on program control, and special purpose function units A0˜An, which are data processing units based on wired logic control, is performed via the main data memory 300 connected to the single data bus 303.

Accordingly, as the number of the special purpose function units A0˜An is increased, the amount of the data transfer on the data bus 303 increases, and a waiting time before transferring data for processing arises. As a result, the problem of a decrease in processing efficiency arises in the data processing system.

### OBJECTS AND SUMMARY OF THE INVENTION

It is an object of the present invention to provide a data processing system with increased data processing efficiency, still maintaining the flexibility in the processing based on the program control and the reduction effect of electric power consumption due to the wired logic control.

A data processing system according to the present invention comprises a first data processing unit, performing processing of data under program control, a plurality of second data processing units, each performing data processing under wired logic control, a storage unit storing data, a first data transfer unit, connecting the first data processing unit and the second data processing unit via the storage unit, and a second data transfer unit, connecting the plural second data processing units.

With this structure, since the second data transfer unit, connecting the plural second data processing units operating under wired logic control is provided, the data transfer between a plurality of the second data processing units can be performed via the second data transfer unit.

From the reason described above, the frequency of the data transfer via the first data transfer unit can be suppressed. Therefore, when a series of processing by the first data processing unit operating under program control and the plurality of the second data processing units operating under wired logic control takes place, a shortening of waiting time in data transfer can be realized.

As a result, the increase of efficiency for the data processing can be realize, without depending on the number of the plurality of the second data processing units.

Furthermore, the flexibility in the data processing by the first data processing unit, operating under program control, and the reduction effect of the electric power consumption due to the second data processing unit, operating under wired logic control, can be maintained.

A first aspect of the present invention provides a data processing system comprising a first data processing unit operable to perform data processing under program control, a plurality of second data processing units, each of the second data processing units operable to perform data processing under wired logic control, a storage unit operable to store data, a first date transfer unit operable to connect the first data processing unit and the plurality of second data processing units, via the storage unit, and a second data transfer unit operable to connect the plurality of second data processing units.

With this structure, since the second data transfer unit, connecting the plural second data processing units operating under wired logic control, is provided, the data transfer between a plurality of the second data processing units can be performed via the second data transfer unit.

From the reason described above, the frequency of data transfer via the first data transfer unit can be suppressed. Therefore, when a series of processing take place in the first data processing unit, operating under program control, and in the plurality of the second data processing units, operating under wired logic control, a shortening of waiting time in data transfer can be realized.

As a result, the increase of efficiency of data processing can be realized without depending on the number of a plurality of the second data processing units.

Furthermore, the flexibility in processing by the first data processing unit, operating under program control, and the reduction effect of the electric power consumption due to the second data processing unit, operating under wired logic control, can be maintained.

A second aspect of the present invention provides a data processing system as defined in the first aspect of the present invention, wherein a bilateral data transfer is carried out between one of the plurality of second data processing units and another of the plurality of second data processing units, using the second data transfer unit. With this structure, the result of processing by one of the second data processing units can be processed by another second data processing unit, and vice versa.

A third aspect of the present invention provides a data processing system as defined in the first aspect of the present invention, wherein an unilateral data transfer is carried out between one of the plurality of second data processing units and another of the plurality of second data processing units, using the second data transfer unit.

With this structure, it is easier to perform control for data transfer in comparison with the case of bilateral data transfer.

A fourth aspect of the present invention provides a data processing system as defined in the first aspect of the present invention, wherein the second data transfer unit is operable to connect one of the plurality of second data processing units and another of the plurality of second data processing units in one-to-one correspondence.

With this structure, it is easier to perform a control for data transfer in comparison with the case of connecting a plurality of the second data processing unit, by the second data transfer unit.

A fifth aspect of the present invention provides a data processing system as defined in the first aspect of the present invention, wherein the second data transfer unit is operable to connect one of the plurality of second data processing units and other of the plurality of second data processing units in one-to-many correspondence.

With this structure, the result of the processing by one of the second data processing units can be transferred to one data processing unit selected from a plurality of the other second data processing units, which are connected each other by a plurality of the second data transfer units. As a result, the flexibility in data processing develops.

A sixth aspect of the present invention provides a data processing system as defined in the first aspect of the present invention, wherein the second data transfer unit is operable to connect the plurality of second data processing units.

With this structure, data transfer among a plurality of the second data processing units mutually connected by the second data transfer unit, can be arbitrarily performed.

A seventh aspect of the present invention provides a data processing system as defined in the first aspect of the present invention, wherein the second data transfer unit is operable to connect the plurality of second data processing units, and wherein an unilateral data transfer is carried out from a prescribed unit of the plurality of second data processing units to a plurality of units of the plurality of second data processing units, using the second data transfer unit.

With this structure, the result of processing in the prescribed second data processing unit can be processed in parallel by the other plural second data processing units. As a result, a high speed processing can be achieved.

A eighth aspect of the present invention provides a data processing system as defined in the first aspect of the present invention, further comprising a third data transfer unit operable to connect the first data processing unit and the second data processing unit.

With this structure, since the third data transfer unit is provided to connect the first data processing unit to the second data processing unit, the result of processing in the first data processing unit or the result of processing in the second data processing unit can be directly transferred between the first data processing unit and the second data processing unit, without using a storage unit or the first data transfer unit.

For this reason, the frequency of data transfer via the first data transfer unit can be suppressed furthermore. As a result, the efficiency of data processing can be increased.

A ninth aspect of the present invention provides a data processing system as defined in the fourth aspect of the present invention, wherein each of the plurality of second data processing units comprises a calculating unit and a fourth data transfer unit operable to connect the calculating unit and the second data transfer unit.

With this structure, without storing temporarily, the result of processing in one of the second processing unit can be directly inputted to another second data processing unit via the second data transfer unit.

For this reason, the processing in one of the second data processing unit and the processing in another second data processing unit for the result of processing of one of the second data processing unit can be performed in parallel. As a result, a high-speed processing can be realized.

A tenth aspect of the present invention provides a data processing system as defined in the first aspect of the present invention, wherein the first data processing unit is operable to control data transfer via the second data transfer unit.

With this structure, data transfer among a plurality of the second data processing units can be program-controlled by the first data processing unit.

As a result data transfer among a plurality of the second data processing units can be freely carried out.

In comparison with a case of providing a special unit to control the data transfer via the second data transfer unit the reduction in the area of circuits to be packaged can be realized.

A eleventh aspect of the present invention provides a data processing system as defined in the eighth aspect of the present invention, wherein the first data processing unit is operable to control data transfer via the third data transfer unit.

With this structure, the data transfer between the first data processing unit and the second data processing unit can be program-control led by the first data processing unit.

As a result a direct data transfer between the first data processing unit and the second data processing unit can be freely performed.

In comparison with a case of providing a special unit to control the data transfer via the third data transfer unit, the reduction in the area of circuits to be packaged can be realized.

A twelfth aspect of the present invention provides a data processing system as defined in the first aspect of the present invention, further comprising a fist data transfer control unit operable to control data transfer via the second data transfer unit.

With this structure, in comparison with a case that the first data transfer unit controls the data transfer via the second data transfer unit, the load of the first data processing unit can be reduced.

A thirteenth aspect of the present invention provides a data processing system as defined in the eighth aspect of the present invention, further comprising a second data transfer control unit operable to control data transfer via the third data transfer unit.

With this structure, in comparison with a case that first data transfer unit controls the data transfer via the third data transfer unit, the load of the first data processing unit can be reduced.

A fourteenth aspect of the present invention provides a data processing system as defined in the first aspect of the present invention, wherein the second data processing unit is operable to perform processing of encoding. With this structure, processing efficiency of encoding can be increase.

A fifteenth aspect of the present invention provides a data processing system as defined in the first aspect of the present invention, wherein the second data processing unit is operable to perform processing of decoding. With this structure, processing efficiency of the decoding can be increase.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram of a moving image encoding/decoding apparatus according to Embodiment 1;

FIG. 2 is a block diagram of a moving image encoding/decoding apparatus according to Embodiment 2;

FIG. 3 is a block diagram of a moving image decoding apparatus according to Embodiment 3;

FIG. 4 is a block diagram of a moving image processing apparatus according to Embodiment 4;

FIG. 5 is a block diagram of a main part of the moving image encoding/decoding apparatus according to Embodiment 5;

FIGS. 6(a) to (h) are a timing chart of the processing by the moving image encoding/decoding apparatus according to Embodiment 5, passing through the local data memories;

FIGS. 7(c) to (h) are a timing chart of the processing by the moving image encoding/decoding apparatus according to Embodiment 5, not passing through the local data memories;

FIG. 8 is a block diagram of a data processing system according to Embodiment 6; and

FIG. 9 is a diagram of a prior-art data processing system.

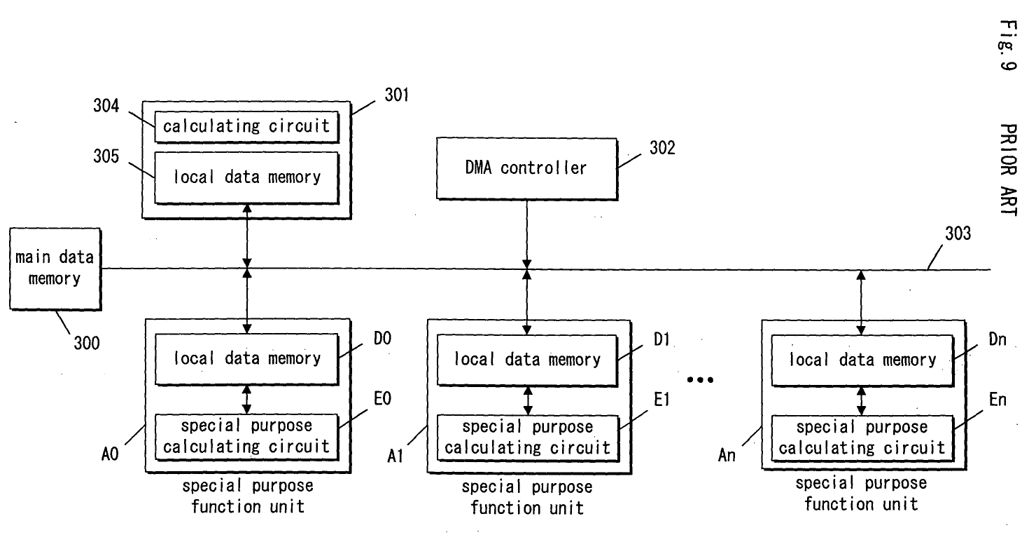

### DETAILED DESCRIPTION OF THE PREFERRED EMBODIMENTS

Herein after, a description is given of embodiments of the invention with reference to the accompanying drawings.

(Embodiment 1)

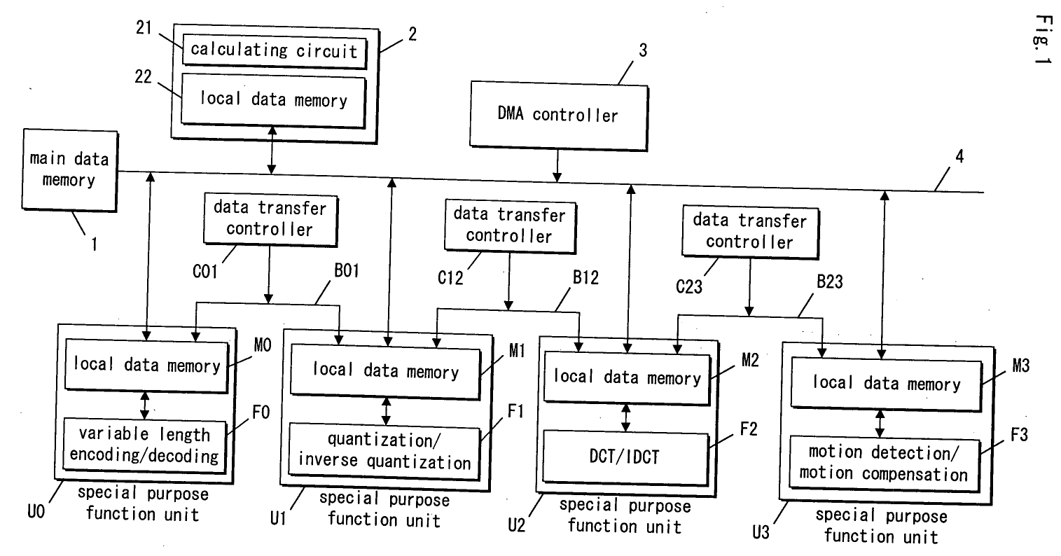

FIG. 1 shows a block diagram of a moving image encoding/decoding apparatus according to Embodiment 1. As shown in FIG. 1, the moving image encoding/decoding apparatus comprises a main data memory 1, a processor 2, a direct memory access controller (DMA controller) 3, a special purpose function units U0˜U3, a data transfer controllers C01, C12, C23, a data bus 4, and a data buses B01, B12, B23.

The processor 2 comprises a calculating circuit 21 and a local data memory 22. The special purpose function unit U0 comprises a local data memory M0 and a variable length encoding/decoding circuit F0. The special purpose function unit U1 comprises a local memory unit M1 and a quantization/inverse quantization circuit F1. The special purpose function unit U2 comprises a local memory unit M2 and a discrete cosine transform/inverse discrete cosine transform (DCT/IDCT) circuit F2. The special purpose function unit U3 comprises a local data memory M3 and a motion detection/motion compensation circuit F3.

The moving image encoding/decoding apparatus corresponds to the data processing system. The processor 2 corresponds to the data processing unit to execute the data processing under program control.

Each of the special purpose function units U0˜U3 corresponds to the data processing unit (a data processing unit consisting of a special purpose hardware with a prescribed function) to execute data processing under wired logic control.

In the present invention, the data buses correspond to units to transfer data.

The data transfer controllers C01, C12, and C23 are collectively expressed as a data transfer controller C.

The special purpose function units U0˜U3 are collectively expressed as a special purpose function unit U.

The local memory units M0˜M3 are collectively expressed as a local memory unit M.

The data bus units B01, B12, and B23 are collectively expressed as a data bus unit B.

The variable length encoding/decoding circuit F0, the quantization/inverse quantization circuit F1, the DCT/DCT circuit F2, and the motion detecting/motion compensation circuit F3 are collectively expressed as a special purpose calculating circuit F.

Now, the function/operation of the respective unit as shown in FIG. 1 is described in brief The main memory 1 stores data. For example, Such results as processed results by the processor 2 or processed results by the special purpose function units U0˜U3 are stored in the main data memory 1.

The processor 2 executes data processing under program control. The local data memory 22 in the processor 2 stores data transferred from the main memory 1 or processed results by the calculating circuit 21.

For example, the processor 2 is a general purpose processor or a general purpose digital signal processor.

The calculating circuit 21 in the processor 2 executes data manipulation or data operation ordered by the instructions. For example, it carries out an operation for the data transferred from the main data memory 1 and stored in the local memory 22, and stores the result of the operation into the local data memory 22.

The local data memory M0 in the special purpose function unit U0 stores the data transferred from the main memory 1, the result of processing in the quantization/inverse quantization circuit F1, or the result of processing in the variable length encoding/decoding circuit F0.

The variable length encoding/decoding circuit F0 in the special purpose function unit U0 performs a processing of variable length encoding/decoding for the data stored in the local data memory M0, and stores the result of the processing into the data memory unit M0.

The local data memory M1 in the special purpose function unit U1 stores the data transferred from the main memory 1, the result of the processing in the variable length encoding/decoding circuit F0, the result of the processing in the quantization/inverse quantization circuit F1, or the result of processing in the DCT/IDCT circuit F2.

The quantization/inverse quantization circuit F1 in the special purpose function unit U1 executes the processing of the quantization or the inverse quantization transform for the data stored in the local data memory M1, and then stores the result of the processing into the data memory unit.

The local data memory M2 in the special purpose function unit U2 stores the data transferred from the main memory 1, the result of the processing in the quantization/inverse quantization circuit F1, the result of the processing in the DCT/IDCT circuit F2, or the result of the processing in the motion detecting motion compensation circuit F3.

The DCT/IDCT circuit F2 in the special purpose function unit U2 executes the processing of the DCT or the IDCT for the data stored in the local memory unit M2, and then stores the result of the processing in the local data memory M2.

The local data memory M3 in the special purpose function unit U3 stores the data transferred from the main data memory 1, the result of the processing in the DCT/IDCT circuit F2, or the result of the processing in the motion detecting motion compensation circuit F3.

The motion detecting motion compensation circuit F3 in the special purpose function unit U3 executes the processing of the motion detecting or the motion compensation for the data stored in the local memory unit M3, and then stores the result of the processing in the local data memory M3.

The DMA controller 3 controls the data transfer between the main data memory 1 and the processor 2, or the data transfer between the main data memory 1 and the special data function units U0˜U3.

The data bus 4 connects the processor 2 to the special data function units U0˜U3 via the main data memory 1.

The data bus 4 executes the data transfer between the main data memory 1 and the processor 2 or the main data memory 1 and the special data function units U0˜U3.

The data transfer controller C01 controls the data transfer between the special purpose function unit U0 and the special purpose function unit U1, via the data bus B01.

The data bus B01 connects the special purpose function unit U0 to the special purpose function unit U 1, and the data bus B01 executes the data transfer between the special purpose function unit U0 and the special purpose function unit U1.

The data transfer controller C12 controls the data transfer between the special purpose function unit U1 and the special purpose function unit U2 via the data bus B12.

The data bus B12 connects the special purpose function unit U1 to the special purpose function unit U2, and the data bus B12 executes the data transfer between the special purpose function unit U1 and the special purpose function unit U2.

The data transfer controller C23 controls the data transfer between the special purpose function unit U2 and the special purpose function unit U3 via the data bus B23.

The data bus B23 connects the special purpose function unit U2 to the special purpose function unit U3, and the data bus B12 executes the data transfer between the special purpose function unit U2 and the special purpose function unit U3.

In the moving image encoding/decoding apparatus as shown in FIG. 1, the operation for an execution of a processing of the moving image encoding or decoding based on the MPEG system is described in the following.

The operation for the execution of an encoding process is described. In case of executing the encoding process, a moving image data as encoding target (called as “encoding target moving image data”, hereinafter), stored in the main memory system 1, is first transferred to the local data memory 22 in the processor 2.

In case of this data transfer, the processor 2 executes a plurality of instructions to transfer the encoding target moving image data, stored in the main memory system 1, to the local data memory 22, and then requests the DMA controller 3 to transfer the data.

The DMA controller 3 performs arbitration between the request of the above-mentioned data transfer and the other requests of the data transfer via the data bus 4, and finally performs the data transfer from the main data memory 1 to the local data memory 22, after accepting the request of the above-mentioned data transfer from the processor 2.

The path for this data transfer is a path leading to the local data memory 22 in the processor 2 from the local data memory 1, via the data bus 4.

The calculating circuit 21 in the processor 2 executes data processing as a preprocessing for the encoding target moving image data, which is transferred from the main data memory 1 and stored in the local data memory 22, and then stores the result of the preprocessing to the local data memory 22.

The preprocessing is, for example, such preprocessing as removal of noise or reordering of frames for bilateral motion compensation.

In order to transfer the encoding target moving image data as a result of preprocessing, to the special purpose function unit U3, the data is temporarily transferred from the local data memory 22 to the main data memory 1.

In case of transferring the data from the local data memory 22 to the main data memory 1, the processor 2 issues a request of the data transfer to the DMA controller 3.

Upon receiving the request, the DMA controller 3 performs arbitration, and then executes the data transfer from the local data memory 22 to the main data memory 1.

This data transfer 3 is similar to the data transfer from the main data memory 1 to the local data memory 22.

The DMA controller 3 informs the processor 2 of the completion of the data transfer, after completing the data transfer.

The path for this data transfer is a path leading to the main data memory 1 from the local data memory 22 in the processor 2 via the data bus 4.

The preprocessed encoding target moving image data, a reference image data, and its parameters, the latter two being required in case of executing a motion detecting in the special purpose function unit U3, are transferred from the main memory 1 to the local data memory M3 in the special purpose function unit U3.

Such a data transfer from the main memory 1 to the local data memory M3 in the special purpose function unit U3 is executed by a program as follows.

The processor 2 receives, from the DMA controller 3, a notice of the completion for the data transfer from the local data memory 22 to the main data memory 1.

After receiving the notice of the completion for the data transfer from DMA controller 3, the processor 2 issues the DMA controller 3 a request of transferring the data necessary for the processing of the motion detecting (the encoding target moving image data after preprocessing, the reference image data, and its parameters) from the main data memory 1 to the local data memory M3.

The DMA controller 3 performs arbitration between the request of the data transfer of the above-mentioned data transfer from the main data memory 1 to the local data memory M3 and the other requests of the data transfer (the request of the data transfer via the data bus B23 and the request of other data transfer via the data bus 4).

The DMA controller 3 performs arbitration between the request of data transfer of the above-mentioned data transferred from the local data memory 1 to the local data memory M3 and the request of the data transfer via the data bus B23, consulting with the data transfer controller C23.

After the above-mentioned arbitration, the DMA controller 3 verifies the status of the special purpose function unit 3. If the data transfer is possible, the DMA controller 3 executes the data transfer from the main data memory 1 to the local data memory M3.

The path for this data transfer is a path leading to the local data memory M3 in the special purpose function unit U3 from the main data memory 1, via the data bus 4.

While the special purpose function unit U3 is in operation and accessing to the local data memory M3, The DMA controller 3 stores the request of data transfer for a while. The DMA controller 3 controls not to execute the data transfer, until the processing in the special purpose function unit U3 completes and the local memory unit M3 is released.

After the above-described data transfer completed, the DMA controller 3 sends a notice of the completion to the processor 2.

After receiving the notice of the completing for the data transfer, the processor 2 executes a series of instructions to start the data processing in the special purpose function unit U3, and then informs the special purpose function unit U3 of the starting of the processing.

After receiving the notice of the starting of the processing from the processor 2, the motion detection/motion compensation circuit F3 in the special purpose function unit U3 executes the processing of the motion detection for the encoding target moving image data, transferred from the main data memory 1 and stored in the local data memory M3.

The motion detection/motion compensation circuit F3 stores into the local data memory M3, a difference data between the encoded target moving image data and the reference image data, as the process result.

The difference data stored in the local data memory M3 in the special purpose function unit U3 is transferred to the local data memory M2 in the special purpose function unit U2 via the data bus B23. The data transfer is described in the following more concretely.

Responding to the completion of storing the difference data in the local memory unit M3, the special purpose transform unit U3 sends, to the data transfer controller C23, a request of the data transfer to the special purpose function unit U2.

While the special purpose function unit U2 is in operation and accessing to the local data memory M2, the data transfer controller C23 stores the request of the data transfer for a while. The data transfer controller C23 controls not to execute the data transfer, until the processing in the special purpose function unit U2 completes and the local memory unit M2 is released.

When the special purpose function unit U2 is not in operation and not accessing to the local data memory M2, the data transfer controller C23 controls to execute immediately the data transfer from the special purpose function unit U3 to the special purpose function unit U2.

In case of executing the above-mentioned data transfer from the special purpose function unit U3 to the special purpose function unit U2, the data transfer controller C23 performs arbitration between the request of the above-mentioned data transfer and the requests of the other data transfer (the request of other data transfer via the data bus B23, the request of the data transfer via the data bus B12, and the request of the data transfer via the data bus 4).

In case of the above-mentioned arbitration, the data transfer controller C23 performs arbitration between the request of the above-mentioned data transfer and the request of the data transfer via the data bus 4, consulting with the DMA controller 3.

The data transfer controller C23 performs arbitration between the request of the above-mentioned data transfer and the request of the data transfer via the data bus B12, consulting with the data transfer controller C12.

As a result of the above-mentioned arbitration, if the special purpose function unit U2 is in a status of accepting the data, the data transfer controller C23 sends the permission of the data transfer to the special purpose function unit U3.

Under the permission of the data transfer, the special purpose function unit U3 transfers the difference data from the local data memory M3 to the local memory unit M2 via the data bus B23.

After the completion of the data transfer, the special purpose function unit U3 sends a notice of the completion for data transfer to the special purpose function unit U2.

As described above, the difference data is transferred from the special purpose function unit U3 to the special purpose function unit M2 via the data bus B23.

After receiving the notice of the completion of the data transfer sent by the special purpose function unit U3, the DCT/IDCT unit P2 in the special purpose function unit U2 executes the discrete cosine transform (DCT) for the difference data stored in the local memory unit M2, and stores into the local memory unit M2 the transform coefficient data as a result of the processing (defined as “DCT coefficient data,” hereinafter).

The DCT coefficient data stored in the local memory unit M2 in the special purpose function unit U2 is transferred to the local memory unit M1 in the special purpose function unit U1 via the data bus B12.

This data transfer is carried out by the data transfer controller C12, after the arbitration between the DMA controller 3 and the data transfer controller C01.

The control of the data transfer by the data transfer controller C12 is similar to the control of the data transfer by the data transfer controller C23.

After the completion of the data transfer, the special purpose function unit U2 sends a notice of completion of the data transfer to the special purpose function unit U1.

After receiving the notice of the completion for the data transfer, sent by the special purpose function unit U2, the quantization/inverse quantization circuit F1 in the special purpose function unit U1 executes the quantization process for the DCT coefficient data stored in the local memory unit M1, and then stores the quantized DCT coefficient data as a result into the local memory unit M1.

The quantized DCT coefficient data stored in the local memory unit M1 in the special purpose function unit U1 is transferred to the local memory unit M0 in the special purpose function unit U0 via the data bus B01.

This data transfer is carried out by the data transfer controller C01, after the arbitration between the DMA controller 3 and the data transfer controller C01.

The control of the data transfer by the data transfer controller C01 is similar to the control of the data transfer by the data transfer controller C23.

After the completion of the data transfer, the special purpose function unit U1 sends a notice of the completion of the data transfer to the special purpose function unit U0.

After receiving the notice of the completion of the data transfer sent by the special purpose function unit U1, the variable length encoding/decoding circuit F0 in the special purpose function unit U0 executes the processing of variable length encoding for the quantization DCT coefficient data stored in the local memory unit M0, and then stores an encoded data as a result in the local memory unit M0.

The special purpose function unit U0 informs the processor 2 of the completion of the encoding.

After receiving the notice of the completion of the encoding from the special purpose function unit U0, the processor 2 executes a series of instructions for the data transfer from the local memory unit M0 to the main data memory 1, and then requests the DMA controller 3 to transfer the data.

The data transfer from the special purpose function unit U0 to the main data memory 1 is performed under program control as follows.

First, the processor 2 receives a notice of the completion for the encoding process from the special purpose function unit U0. After receiving the notice of the completion for the encoding process, the processor 2 issues, to the DMA controller 3, a request for the data transfer from the local memory unit M0 to the main data memory 1.

The DMA controller 3 performs arbitration between the request of the concerned data transfer from the local data memory M0 to the main data memory 1 and the request of other data transfer via the data bus 4.

After this arbitration, the DMA controller 3 verifies the status of the special purpose function unit U0. If the data transfer is possible, the DMA controller 3 executes the data transfer from the local data memory M0 to the main data memory 1.

The path for the data transfer is a path leading to the main data memory 1 from the local data memory M0 in the special purpose function unit U0, via the data bus 4.

After the completion of the above-mentioned data transfer, the DMA controller 3 informs the processor 2 of the completion of the data transfer.

As described above, the encoding process is executed.

The arbitration between the DMA controller 3 and the data transfer controllers C01, C12 and C23 is described in detail.

For example, it is assumed that the processor 2 executes, under program control, a series of instructions to transfer a part of data stored in the main memory 1 to the local data memory M0 in the special purpose function unit U0 via the data bus 4, and then issues a request for the data transfer to the DMA controller 3.

It is also assumed that, when the special purpose function unit U1 completes to store the result of the processing for the quantized DCT coefficient data into the local data memory M1, the special purpose function unit U1 issues a request of the data transfer to the data transfer controller C01, in order to transfer the quantized DCT coefficient data to the special purpose function unit U0 via the data bus B01.

When the requests of the data transfer to the special purpose function unit U0 conflict each other, the DMA controller 3 and the data transfer controller C01 monitor their own status to control the execution of the data transfer. The process is described in the following.

While the data transfer requested from the processor 2 is executed by the DMA controller 3, the data transfer controller C01 controls to execute the data transfer in response to the request of data transfer from the special purpose function unit U1, after the completion of the data transfer in response to the request of data transfer from the processor 2.

Inversely, while the data transfer requested from the special purpose function unit U1 is executed by the data transfer controller C01, the DMA controller 3 controls to execute the data transfer in response to the request of the data transfer from the processor 2, after the completion of the data transfer in response to the request of data transfer from the special purpose function unit U1.

As described above, the arbitration between the DMA controller 3 and the data transfer controller C01 is performed. In the examples, the conflicting requests of data transfer to the special purpose function unit U0 are described. Conflicting requests of data transfer to the special purpose function units U U3 are also solved under a similar arbitration.

Now, the operation for the executing of the decoding is described. The processing of the decoding can be realized by an inverse flow of the encoding. In the inverse sequence against the encoding, the data transfer is performed as from the special purpose function unit U0, to the special purpose function unit U1, to the special purpose function unit U2, and to the special purpose function unit U3. The processing is concretely executed as follows.

First an encoded data as a decoding target (called as “decoding target encoded data”, hereinafter) is transferred from the main data memory 1 to the local memory unit M0 in the special purpose function unit U0.

Such data transfer from the main data memory 1 to the local memory unit M0 in the special purpose function unit U0 is executed under program control as follows.

The processor 2 issues, to the DMA controller 3, a request of data transfer for the decoding target encoded data from the main data memory 1 to the local data memory M0.

The DMA controller 3 performs arbitration between the above-mentioned request of data transfer from the main data memory 1 to the local data memory M0 and other requests of the data transfer (other requests of the data transfer via the data bus 4 and the request of the data transfer via the data bus B01).

In this case, the DMA controller 3 performs arbitration between the concerned request of data transfer and the request of the data transfer via the data bus B01, consulting with the data transfer controller C01.

After the above-mentioned arbitration, the DMA controller 3 verifies the status of the special purpose function unit U0. If the data transfer is possible, the DMA controller 3 executed the data transfer to the local memory M0 from the main data memory 1.

The path for the data transfer is a path from the main data memory 1 to the local data memory M0 in the special purpose function unit U0, via the data bus 4.

While the special purpose function unit U0 is in operation and accessing to the local data memory M0, the DMA controller 3 stores the above-mentioned request of data transfer for a while. The DMA controller 3 controls not to execute the data transfer, until the processing in the special purpose function unit U0 is completed and the local memory M0 is released.

After the completion of the above-mentioned data transfer, the DMA controller 3 sends a notice of the completion for the data to the processor 2.

After receiving the notice of the completion for the data transfer, the processor 2 executes a series of instructions to start the processing in the special purpose function unit U0, and then informs the special purpose function unit U0 of the starting of the processing.

After receiving the notice of the start of the processing from the processor 2, the variable length encoding/decoding circuit F0 in the special purpose function unit U0 executes the processing of the variable length decoding for the decoding target encoded data, transferred from the main data memory 1 and stored in the local data memory M0.

The variable length encoding/decoding circuit F0 stores the resultant quantized DCT coefficient data in the local data memory M0.

The quantized DCT coefficient data stored in the local data memory M0 in the special purpose function unit U0 is transferred to the local memory M1 in the special purpose function unit U1 via the data bus B01. The data transfer is concretely described in the following.

Responding to the completion of storing the quantized DCT coefficient data in the local memory M0, the special purpose function unit U0 sends the data transfer controller C01 a request of the data transfer to the special purpose function unit U1.

While the special purpose function unit U1 is in operation and accessing to the local data memory M1, the data transfer controller C01 stores the above-mentioned request of data transfer for a while. The data transfer controller C01 controls not to execute the data transfer, until the processing by the special purpose function unit U1 is completed and the local memory M1 is released.

While the special purpose function unit U1 is not in operation and not accessing to and the local data memory M1, the data transfer controller C01 controls to execute immediately the data transfer from the special purpose function unit U0 to the special purpose function unit U1.

In case of executing the above-mentioned control for the data transfer from the special purpose function unit U0 to the special purpose function unit U1, the data transfer controller C01 performs arbitration between the concerned request of the data transfer and other requests of data transfer (the request of the data transfer via the data bus 4, the other requests of data transfer via the data bus B01, and the request of the data transfer via the data bus B12).

In this case, the data transfer controller C01 performs arbitration between the above-mentioned request of the data transfer and the request of the data transfer via the data bus 4, consulting with the DMA controller 3.

The data transfer controller C01 performs arbitration between the concerned request of the data transfer and the request of the data transfer via the data bus B12, consulting with the data transfer controller C12.

As a result of the above-mentioned arbitration, if the special purpose function unit U1 is in the state of accepting the data, the data transfer controller C01 sends the permission of the data transfer to the special purpose function unit U0.

After receiving the permission of the data transfer, the special purpose function unit U0 transfers the quantized DCT coefficient data from the local memory M0 to the local memory M1 via the data bus B01.

After the completion of the data transfer, the special purpose function unit U0 sends a notice of the completion for the data transfer to the special purpose function unit U1.

As described above, the quantized DCT coefficient data is transferred from the special purpose function unit U0 to the special purpose function unit U1 via the data bus B01.

After receiving the notice of the completion for data transfer sent by the special purpose function unit U0, the quantization/inverse quantization circuit F1 in the special purpose function unit U1 executes the inverse quantization process for the quantized DCT coefficient data stored in the local memory M1, and then stores the resultant DCT coefficient data into the local memory M1.

The DCT coefficient data, stored in the local memory M1 in the special purpose function unit U1, is transferred to the local memory M2 in the special purpose function unit U2 via the data bus B12.

The data transfer is carried out by the data transfer controller C12, after the arbitration between the DMA controller 3 and the data transfer controller C23.

The control of the data-transfer by the data transfer controller C12 is similar to the control of data transfer by the data transfer controller C01.

After the completion of the data transfer, the special purpose function unit U1 sends a notice of the completion for the data transfer to the special purpose function unit U2.

After receiving the notice of the completion for the data transfer sent by the special purpose function unit U1, the DCT/IDCT circuit F2 in the special purpose function unit U2 executes the processing of the inverse discrete cosine transform for the DCT coefficient data stored in the local memory M2, and then stores the resultant difference data into the local memory M2.

The difference data stored in the local memory M2 in the special purpose function U2 is transferred to the local memory M3 in the special purpose function unit U3 via the data bus B23.

The data transfer is carried out by the data transfer controller C23, after the arbitration between the DMA controller 3 and the data transfer controller C23.

The control of the data transfer by the data transfer controller C23 is similar to the control of the data transfer by the data transfer controller C01.

After the completion of the data transfer, the special purpose function unit U2 sends a notice of the completion for the data transfer to the special purpose function unit U3.

After receiving the notice of the completion for the data transfer sent by the special purpose function unit U2, the motion detection/motion compensation circuit F3 in the special purpose function unit U3 executes the processing of the motion compensation for the difference data stored in the local memory M3, and then stores the resultant decoded moving image data into the local memory M3.

A reference image data for the motion compensation is transferred to the local memory M3 via the data bus 4 in advance.

After storing the decoded moving image data into the special purpose function unit U3, the special purpose function unit U3 sends a notice of the completion for the decoding process to the processor 2.

After receiving the notice of the completion for the decoding process from the special purpose function unit U3, the processor 2 executes a series of instructions for data transfer from the local memory M3 to the main memory 1, and then requests the DMA controller 3 to transfer the data.

The data transfer from the special purpose function unit U3 to the main memory 1 is performed under program control as follows.

First, the processor 2 receives a notice of the completion for the decoding process from the special purpose function unit U3. After receiving the notice of the completion for the decoding process, the processor 2 issues, to the DMA controller 3, a request of the data transfer for the decoding data from the local memory M3 to the main memory 1.

The DMA controller 3 performs arbitration between the concerned request of the data transfer from the local memory M3 to the main memory 1 and the other requests of data transfer via the data bus 4.

The DMA controller 3 confirms the status of the special purpose function unit U3 after the arbitration. If the data transfer is possible, the DMA controller 3 executes the data transfer from the local memory M3 to the main memory 1.

The path for the data transfer is a path leading to the main data memory 1 from the local data memory M3 in the special purpose function unit U3, via the data bus 4.

After the completion of the above-mentioned data transfer, the DMA controller 3 sends a notice of the completion for the decoding process to the processor 2.

Upon receiving the notice of the completion for the data transfer, the processor 2 transfers the decoded moving image data stored in the main data memory 1 to the local data memory 22.

To perform this data transfer, the processor 2 executes a series of instructions to transfer the decoded moving image data stored in the main memory 1 to the local data memory 22, and then issues a request of the data transfer to the DMA controller 3.

The DMA controller 3 performs arbitration between the concerned request of the data transfer and the other requests of the data transfer via the data bus 4, and then finally accepts the concerned request of the data transfer from the processor 2, and executes the data transfer from the main data memory 1 to the local data memory 22.

The path for this data transfer is a path from the main data memory 1 to the local data memory 22 of the processor 2 via the data bus 4.

The calculating circuit 21 of the processor 2 executes data processing as postprocessing for the decoded moving image data transferred from the main data memory 1 and stored in the local data memory 22, and then stores the processed result into the local data memory 22. The postprocessing includes such processing as noise reduction, for example.

The resultant postprocessed decoded moving image data is transferred from the local data memory 22 to the main memory 1.

In case of transferring the data from the local data memory 22 to the main data memory 1, the processor 2 issues a request of the data transfer to the DMA controller 3.

The DMA controller 3, after receiving the request, performs arbitration, and then executes the data transfer from the local data memory 22 to the main data memory 1.

This process is similar to the process of the data transfer to the local data memory 22 from the main data memory 1.

The DMA controller 3 informs the processor 2 of the completion of the data transfer.

The path for this data transfer is a path leading to the main data memory 1 from the local data memory 22 in the processor 2 via the data bus 4.

As described above, the decoding process is executed.

In Embodiment 1, the data buses B01, B12, and B23 are provided, connecting to the special purpose function units U0˜U3 operable under wired logic control.

With this structure, the data transfer between the special purpose function units U0 and U1 can be performed via the data bus B01. The data transfer between the special purpose function units U1 and U2 can be performed via the data bus B12. The data transfer between the special purpose function units U2 and U3 can be performed via the data bus B23.

As a result, the frequency of data transfer via the data bus 4 can be suppressed. In case of executing a series of processing (a series of processing for encoding, a series of processing for decoding) by the processor 2 operable under program control and by the special purpose function units U0˜U3 operable under wired logic control, the waiting time for the data transfer can be reduced.

As a result, the increase of efficiency for the data processing can be realize without depending on the number of the special purpose function units U0˜U3.

Furthermore, both the flexibility in the data processing by the processor operable under program control and the reduction of electric power consumption due to the special purpose function units U0˜U3 operable under wired logic control can be maintained.

In Embodiment 1, a bilateral data transfer among the special purpose function units U can be performed via the data bus B.

Therefore, the result of processing by one special purpose function unit U can be processed by another special purpose function unit U, and vice verse.

In Embodiment 1, one special purpose function unit U is connected to another special purpose function unit U, in one-to-one correspondence, via the data bus B.

For example, a special purpose function unit U0 is connected to a special purpose function unit U1, in one-to-one correspondence, via the data bus B01.

In comparison with a case of connection in one-to-many correspondence, the control of the data transfer can more easily performed and the reduction in the area of circuits to be packaged can be realized.

In the data transfer described above, according to the completion of storing the result of processing into the local memory M, the special purpose function unit U requests the data transfer controller C to transfer the data.

The processor 2 can also request the data transfer as follows. The special purpose function unit U sets a flag according to the completion of storing the result of the processing in the local memory M, or the special purpose function unit U sends the processor 2 an interrupt signal according to the completion of storing the result of the processing in the local data memory M. Either the flag or the interrupt signal can be used to inform the processor that the storage of the result of the processing into the local data memory M is completed.

By judging the completion of the processing in the special purpose function unit U, the processor 2 executes a series of instructions to transfer the result of the processing stored in the concerned local memory M to another local data memory M connected to the concerned local data memory M, and issues, to the data controller C, a request of the data transfer.

In the above process, when the concerned special purpose function unit U completes the data transfer to another special purpose function unit U connected to the concerned special purpose function unit U, the concerned special purpose function unit U informs the other special purpose function unit U of the completion of the data transfer.

By a trigger of receiving the notice of the completion for data transfer from the concerned special purpose function unit U, the other special purpose function units U awake special purpose calculating circuits F to operate, thus the calculation process is executed.

The special purpose calculating circuits F can also start operating by the control of the processor 2 as follows.

When the data transfer to the other special purpose function unit U connected to the concerned special purpose function unit U completes, the concerned special purpose function unit U informs the processor 2 of the completion of the data transfer.

After receiving the notice of the completion for the data transfer from the concerned special purpose function unit U, the processor 2 issues, under program control, a series of instructions to the concerned other special purpose function units U, to start the concerned special purpose calculating circuits F.

In the above-mentioned case, the control of data transfer via the data bus B among a plurality of the special purpose function units U is performed by the data transfer controller C.

However, the control of data transfer via the data bus B among a plurality of the special purpose function units U can also be performed by the processor 2. The point is explained referring to a concrete example.

As an example, a data transfer from a special purpose function unit U0 to a special purpose function unit U1 is explained for the case of decoding.

When the processing of variable length decoding is completed in the special purpose function unit U0 and the data storage into the local data memory M0 is completed, the special purpose function unit U0 informs the processor 2 of the completion of the processing of variable length decoding.

Upon receiving the notice, the processor 2 conforms the status of the special purpose function unit U1. If the special purpose function unit U1 is in an acceptable status for data transfer, the processor 2 sends a notice of the permission for the data transfer to the special purpose function unit U0.

The special purpose function unit U0 receives the notice of the permission for the data transfer, and transfers the data stored in the local data memory M0 to the local data memory M1 via the data bus B01.

After the completion of the data transfer, the special purpose function unit U0 sends a notice of the completion of the data transfer to the processor 2.

By the method described above, the data transfer among a plurality of the special purpose function units U via the data bus B is also possible.

In case that the processor 2 controls the data transfer via the data bus B, the data transfer controller C is unnecessary, and the reduction in the area of circuits to be packaged can realized.

In this case, furthermore, the data transfer via the data bus among a plurality of the special purpose function units U become possible to be program-controlled by the processor 2. As a result, the data transfer among a plurality of the special purpose function units U can be freely performed.

In case that the data transfer controller C performs the control of the data transfer via the data bus B, the load of the processor 2 can be reduced.

The processes of encoding and decoding for the moving image data have been explained as the processing of inter frame encoding and inter flame decoding, respectively.

The processing of intra flame encoding and intra frame decoding can also be performed in a similar manner as described above, by the sequence of the operations excluding the processing of the special purpose function unit U3.

In the above-mentioned case, the special purpose function unit U comprises special purpose calculating circuits F to execute encoding and decoding processes.

The function of the special purpose calculating circuits F is not limited to the one mentioned above, and special purpose calculating circuits F with arbitrary functions can be included within the present embodiment.

In the above-mentioned case, it is assumed that the number of special purpose function units U is four, the number of data transfer controllers is three, and the number of data buses is three. These numbers are not limited to this case and can be set arbitrarily. One data bus comprises a plurality of signal lines.

(Embodiment 2)

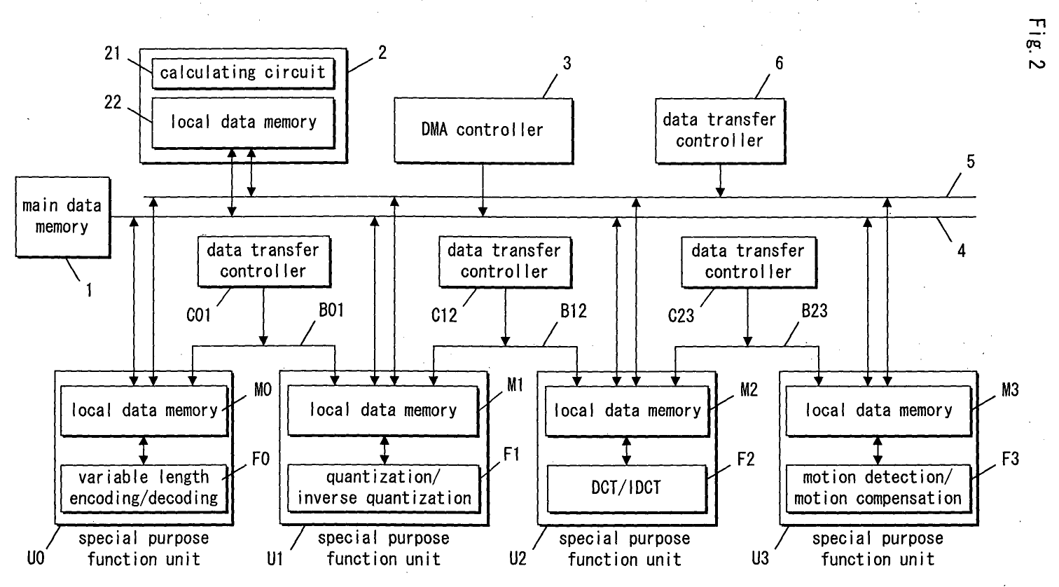

FIG. 2 shows a block diagram of a moving image encoding/decoding apparatus according to Embodiment 2. In FIG. 2, the same units are labeled by the same symbols as in FIG. 1, and the explanation for these is omitted.

As shown in FIG. 2, the data processing system according to the present embodiment comprises a data transfer controller 6 and a data bus 5, in addition to the configuration of the data processing system as shown in FIG. 1.

The encoding processing is explained focusing on the different features from Embodiment 1.

According to Embodiment 1, after an encoding target moving image data preprocessed by a processor 2 is stored in the local memory 22 of the processor 2, the data is transferred to the main data memory via the data bus 4. The data is transferred to the local memory M3 of the special purpose function unit U3 via the data bus 4, and then the data is processed by the motion detecting/motion compensation circuit F3.

On the other hand, according to Embodiment 2, after an encoding target moving image data preprocessed by the processor 2 is stored in the local memory of the processor 2, the data is transferred to the local memory M3 of the special purpose function unit U3 via the data bus 5, and then the data is processed by the motion detection/motion compensation circuit F3. The detail is described in the following.

In case of transferring the data from the local data memory 22 of the processor 2 to the local data memory M3, the processor 2 issues a data transfer request to the data transfer controller 6.

The data transfer controller 6 performs arbitration between the request of the data transfer from the local data memory 22 of the processor 2 to the local data memory M3 of the special purpose function unit U3 and the request of the data transfer via the data bus B23, consulting with the data transfer controller 23.

The data transfer controller 6 confirms the status of the special purpose function unit U3 after the arbitration. When the data transfer is possible, the data transfer controller 6 executes the data transfer from the local memory 22 to the local data memory M3.

After the data transfer is completed, the data transfer controller 6 informs the processor 2 of the completion for the data transfer.

The path for this data transfer is a path from the local data memory 22 of the processor 2 to the local data memory M3 in the special purpose function unit U3 via the data bus 5.

While the special purpose function unit U3 in operation and accessing to the local data memory M3, the data transfer controller C6 stores the above-mentioned request of the data transfer for a while, and controls not to execute the data transfer, until the processing by the special purpose function unit U3 is completed, and the local memory M3 is released.

After receiving the notice of the completion for the data transfer, the processor 2 executes a series of instructions for the starting of the processing in the special purpose function unit U3, and then informs the special purpose function unit U3 of the starting for the processing.

Upon receiving the notice, the motion detection/motion compensation circuit F3 in the special purpose function unit U3 executes the motion detection process for the encoding target moving image data, and then stores the difference data as a result into the local data memory M3.

The difference data stored in the local data memory M3 is transferred to the local data memory M3, under the control of the data transfer controller C23.

In this data transfer, in addition to the arbitration between the DMA controller 3 and the data transfer controller C12, similarly to the case in the first embodiment, the data transfer controller C23 performs arbitration between the above-mentioned request of the data transfer and the request of the data transfer via the data bus 5 between the local data memory 22 of the processor 2 and the local data memory M2, consulting with the data transfer controller 6.

The DCT/IDCT circuit F2 executes the DCT/IDCT process for the difference data stored in the local data memory M2, and then stores the resultant DCT coefficient data into the local data memory M2.

The DCT coefficient data stored in the local data memory M2 is transferred to the local data memory M1, under the control of the data transfer controller C12.

In this data transfer, in addition to the arbitration between the DMA controller 3 and the data transfer controller C01, similarly to the case in the first embodiment, the data transfer controller C12 performs arbitration between the above-mentioned request of the data transfer and the request of the data transfer via the data bus 5 between the local data memory 22 and the local data memory M1, consulting with the data transfer controller 6.

The quantization/inverse quantization circuit F1 executes the processing of the quantization for the DCT coefficient data stored in the local data memory M1, and then stores the resultant quantized DCT coefficient data into the local data memory M1.

The processor 2 performs an adaptive processing for the quantized DCT coefficient data stored in the local data memory M1.

In this case, in order to perform the adaptive processing, the processor 2 transfers the quantized DCT coefficient data stored in the local data memory M1 to the local data memory 22 in the processor 2. The detail is described in the following.

The processor 2 executes a series of instructions to transfer the quantized DCT coefficient data stored in the local data memory M1 to the local data memory 22, and issues the request of the data transfer to the data transfer controller 6.

The data transfer controller 6 performs arbitration between the above-mentioned request of the data transfer and other requests of the data transfer (the request of the data transfer via the data bus 4, the request of the data transfer via the data bus B01, the request of the data transfer via the data bus B12 and the request of the data transfer via the data bus 5), and finally accepts the above-mentioned request of the data transfer by the processor 2, and then performs the data transfer from the local data memory M1 to the local data memory 22 of the processor 2.

The path for this data transfer is a path from the local data memory M1 to the local data memory 22 of the processor 2 via the data bus 5.

The data transfer controller 6 performs arbitration between above-mentioned request of the data transfer and the request of the data transfer via the data bus 4, consulting with the DMA controller 3.

The data transfer controller 6 performs arbitration between the above-mentioned request of data transfer and the request of the data transfer via data bus B01, consulting with the data transfer controller C01.

The data transfer controller 6 performs arbitration between the above-mentioned request of data transfer and the request of the data transfer via the data bus B12, consulting with the data transfer controller C12.

The calculating circuit 21 of the processor 2 performs an adaptive processing for the quantized DCT coefficient data that is transferred from the local data memory M1 and stored in the local data memory 22.

The following processing is performed as the adaptive processing, for example. The processor 2 counts the number of quantized DCT coefficient data whose value is equal to “0”, and calculates the maximum value of the absolute values for the quantized DCT coefficient data whose value is not equal to “0”.

When the number of the quantized DCT coefficient data, whose values equal to “0”, is larger than a first predetermined threshold, and the maximum value of the absolute values for the quantized DCT coefficient date, whose values do not equal to “0”, is smaller than a second predetermined threshold, the processor 2 does not execute the processing of the encoding target moving image data, because the processor 2 decides that the encoding target moving image data, which corresponds to the quantized DCT coefficient data transferred from the local data memory M1, is same as the reference image data. Afterwards, the processor 2 stops the subsequent encoding process for the above-mentioned quantized DCT coefficient data.

By performing the above-mentioned adaptive processing, the improvement of efficiency for the encoding and the reduction of the amount of processing for the encoding can be possible.

On the other hand, when the number of the quantized DCT coefficient data, whose values equal to “0”, is smaller than the first predetermined threshold, or the maximum value of the absolute values for the quantized DCT coefficient data, whose values do not equal to “0” is larger than the second predetermined threshold, the processor 2 continues the processing for the above-mentioned quantized DCT coefficient data, alter the processor 2 decides that the encoding target moving image data, which corresponds to the quantized DCT coefficient data transferred from the local data memory M1, is not same as the reference data.

When the encoding processing is continued, the quantized DCT coefficient data stored in the local data memory M1 is transferred to the local memory M0, under the control of the data transfer controller C01. In this transfer, in addition to the arbitration by the DMA controller, as in the first embodiment, the data transfer controller C01 performs arbitration between the above-mentioned request of the data transfer and the request of the data transfer between the local data memory 22 of the processor 2 and the local data memory M0 via the data bus 5, consulting with the data transfer controller 6.

The variable length encoding/decoding circuit F0 performs the processing of the variable length encoding for the quantized DCT coefficient data stored in the local data memory M0, and stores the resultant encoding data into the local data memory M0.

The encoding data stored in the local data memory M0 is transferred to the main data memory 1, under the control of the DMA controller 3.

The decoding processing is now described, focusing on different features from Embodiment 1. The processing of the decoding can be realized by an inverse flow of the encoding. Contrary to the encoding processing, the data is transferred from the special purpose function unit U0, to the special purpose function unit U1, to the special purpose function unit U2, and to the special purpose function unit U3, in this sequence. The processing is more specified in the following.

The decoding target encoded data stored in the main data memory 1 is transferred to the local memory M0 via the data bus 4, under the control of the DMA controller 3.

In this data transfer, in addition to the arbitration with the data transfer controller C01, as in Embodiment 1, the DMA controller 3 performs arbitration between the above-mentioned request of the data transfer and the request of the data transfer between the local data memory 22 and the local data memory M0 via the data bus 5, consulting with the data transfer controller 6.

The variable length encoding/decoding circuit F0 executes the processing of variable length decoding for the decoding target encoded data stored in the local memory M0, and then stores the resultant quantized DCT coefficient data into the local memory M0.

The quantized DCT coefficient data stored in the local data memory M0 is transferred to the local memory M1, under the control of the data transfer controller C01.

In this transfer, in addition to the arbitration between the DMA controller 3 and the data transfer controller C12, as in Embodiment 1, the data transfer controller C01 performs arbitration between the above-mentioned request of the data transfer and the request of the data transfer between the local data memory 22 of the processor 2 and the local data memory M1 via the data bus 5, consulting with the data transfer controller 6.

The quantization/inverse quantization circuit F1 executes the inverse quantization for the quantized DCT coefficient data stored in the local memory M1, and then stores the resultant DCT coefficient data into the local memory M1.

The DCT coefficient data stored in the local memory M1 is transferred to the local memory M2, under the control of the data transfer controller C12.

In this transfer, in addition to the arbitration between the DMA controller 3 and the data transfer controller C23, as in Embodiment 1, the data transfer controller C12 performs arbitration between the above-mentioned request of the data transfer and the request of the data transfer between the local data memory 22 of the processor 2 and the local data memory M2 via the data bus 5, consulting with the data transfer controller 6.

The DCT/IDCT circuit F2 executes the inverse discrete cosine transform process for the DCT coefficient data stored in the local memory M2, and then stores the resultant difference data into the local memory M2.

The difference data stored in the local data memory M2 is transferred to the local data memory M3, under the control of the data transfer controller C23.

In this transfer, in addition to the arbitration from the DMA controller, as in Embodiment 1, the data transfer controller C23 performs arbitration between the above-mentioned request of the data transfer and the request of the data transfer between the local data memory 22 of the processor 2 and the local data memory M3 via the data bus 5, consulting with the data transfer controller 6.

The motion detecting/motion compensation circuit F3 executes the motion compensation process for the difference data stored in the local data memory M3, and then stores the resultant decoded moving image data into the local memory M3.

In Embodiment 1, the decoded moving image data stored in the local data memory M3 is transferred to the main memory 1 via the data bus 4, and is transferred to the local data memory 22 in the processor 2, and then the postprocessing is performed.

Contrary to Embodiment 1, in the present embodiment, the decoded moving image data stored in the local data memory M3 is transferred to the local data memory 22 of the processor 2 via data bus 5, and then the postprocessing is performed. The detail is described in the following.

When the data is transferred from the local memory M3 of the special purpose function U3 to the local memory unit 22 of the processor 2, the processor 2 issues a request of the data transfer to the data transfer controller 6.

The data transfer controller 6 performs arbitration between the above-mentioned request of the data transfer and other requests of the data transfer via the data bus 5.

The data transfer controller 6 performs arbitration between the above-mentioned request of the data transfer and other requests of data transfer via the data bus 4, consulting with the DMA controller 3.

The data transfer controller 6 confirms the status of the special purpose function unit 3. When the data transfer is possible, the data transfer controller 6 performs the data transfer from the local data memory M3 to the local data memory 22.

The data transfer controller 6 informs the processor 2 of the completion for the data transfer.

The path for this data transfer is a path from the local data memory M3 of the special purpose function unit U3 to the local data memory 22 of the processor 2 via the data bus 5.

While the special purpose function unit U3 is in operation and accessing to the local data memory M3, the data transfer controller 6 stores the above-mentioned request of data transfer for a while, and controls not to execute the data transfer, until the processing by the special purpose function unit U3 completes and the local memory M3 is released.

After the processor 2 receives the notice of the completion for the data transfer, the processor 2 executes the postprocessing for the decoded moving image data stored in the local data memory 22, and then stores the result data into the local memory 22.

The postprocessed decoded moving image data stored in the local data memory 22 is transferred to the main memory 1 via the data bus 4, under the control of the DMA controller 3.

After the data transfer is completed, the DMA controller 3 informs the processor 2 of the completion for the data transfer.

As described above, Embodiment 2 comprises the same configuration as in Embodiment 1. For this reason, the present embodiment can improve the efficiency of the data processing, while maintaining flexibility of data processing under program control and reduction of the electric power consumption. Furthermore, the present embodiment has the same effects as in Embodiment 1.

In the present embodiment, the data bus 5 directly connects the processor 2 and the special purpose function units U0˜U3.

According to this fact, the processed results of the processor 2 and the special purpose function units U0˜U3 are bilaterally received and sent between them, without passing through the main data memory 1 and the data bus 4.

For the above-mentioned reason, the frequency of the data transfer via the data bus 4 can be suppressed As a result, the efficiency of data transfer can be improved.

In the case described above, the data bus 5 is connected to all special purpose function units U0˜U3, but the connecting destinations from the data bus 5 can be arbitrarily set.

As described above, the control of the data transfer between the special purpose function units U0˜U3 and the local data memory 22 via the data bus 5 is performed by the data transfer controller 6.

Such control of the data transfer can also be performed by the processor 2.

In case that the processor 2 performs the control of the data transfer via the data bus 5, the data transfer controller 6 becomes unnecessary. Therefore, the reduction in the area of circuits to be packaged can be realized.

Furthermore, in this case, the data transfer between the processor 2 and the special purpose function units U0˜U3 via the data bus 5 can be performed by the processor 2 under program control. As a result, a direct data transfer between the processor 2 and the special purpose function units U0˜U3 can be freely performed.

On the other hand, in case that the data transfer controller 6 performs the control of the data transfer via the data bus 5, the load of the processor 2 can be reduced

(Embodiment 3)

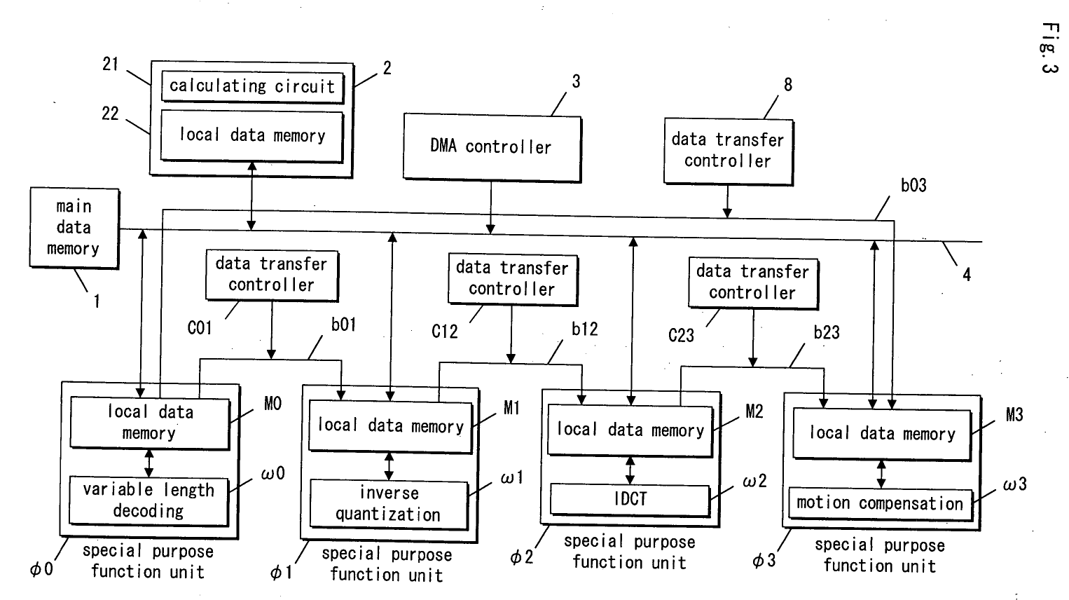

FIG. 3 shows a block diagram of a moving image decoding apparatus according to Embodiment 3. In FIG. 3, the same components as in FIG. 1 are labeled with the same symbols as in FIG. 1, and their explanations are properly omitted.

As shown in FIG. 3, the moving image decoding unit comprises a main data memory 1, a processor 2, a direct memory access (DMA) controller 3, special purpose function units φ0˜φ3, data transfer controllers C01, C12, C23, a data buses b01, b12, b23, a data transfer controller 8, and a data bus b03. The processor 2 comprises a calculating circuit 21 and a local data memory 22.

The special purpose function unit φ0 comprises a local data memory M0 and a variable length decoding circuit ω0. The special purpose function unit φ1 comprises a local data memory M1 and an inverse quantization circuit ω1. The special purpose function unit φ2 comprises a local data memory M2 and an inverse discrete cosine transform circuit (IDCT circuit) ω2. The special purpose function unit φ3 comprises a local data memory M3 and a motion compensation circuit ω3.

The moving image decoding unit corresponds to a data processing system. The processor 2 corresponds to a data processing unit for executing data processing under program control.

Each of special purpose function units φ0˜φ3 corresponds to a data processing unit (special purpose function unit with a designated function) for executing data processing under wired logic control.

The data transfer controllers C01, C12, C23, and 8 are collectively expressed as a data transfer controller C.

The special purpose function units φ0˜φ3 are collectively expressed as a special purpose function unit 4.

The local data memories M0˜M3 are collectively expressed as a local data memory M.

The data buses 01, b12, b23 and b03 are collectively expressed as a data bus b.

The variable length decoding circuit ω0, the inverse quantization decoding circuit ω1, the IDCT circuit ω2, and the motion compensation circuit ω3 are collectively expressed as a special purpose calculating circuit ω.

The data bus 4 connects the processor 2 and the special purpose function units φ0˜φ3 via the main memory 1.

The data bus b01 connects the special purpose function unit φ0 and the special purpose function unit φ1. The data bus b12 connects the special purpose function unit φ1 and the special purpose function unit φ2. The data bus b23 connects the special purpose function unit φ2 and the special purpose function unit φ3. The data bus b03 connects the special purpose function unit φ0 and the special purpose function unit φ3.

The decoding process is explained, focusing on the different features from the decoding process described in Embodiment 1. The decoding target encoded data stored in the main memory 1 is transferred to the local memory unit M0 via the data bus 4, under the control of DMA controller 3.

The variable length decoding circuit ω0 executes the processing of variable length decoding and stores the resultant quantized DCT coefficient data into the local data memory M0.

As one of the codes for variable length encoding in MPEG4 moving image coding system, there is a code called as “not-coded”, which is applied to a macro block with no motion detected in the motion detection.

The “not-coded” code indicates that all the quantized DCT coefficient data in the macro block is “0”. The code is one of the codes provided for the reduction of an amount of encoded data after the variable length encoding.

When the code “not-coded” is detected in the process of variable length decoding, it is unnecessary to subsequently execute the inverse quantization process and the inverse discrete cosine transform process. The reference image in the motion compensation process can be regarded as the resultant decoded image.

Therefore, when the code “not-coded” is detected in the special purpose function unit 40, data “0” is stored into the local data memory M0 of the special purpose function unit φ0.

The data “0” stored in the local data memory M0 is transferred to the local data memory M3 of the special purpose function unit φ3 via the data bus b03, by the control of the data transfer controller 8.

In this data transfer, the data transfer controller 8 performs arbitration between the request of the concerned data transfer and the request of the data transfer via the data bus b23, consulting with the data transfer controller C23.

The data transfer controller 8 performs arbitration between the request of the concerned data transfer and the request of the data transfer via the data bus 4, consulting with the DMA controller 3.

After the arbitration, the data transfer controller 8 verifies the status of the special purpose function unit φ3. If the special purpose function unit φ3 is in the acceptable state for the data transfer, the data “0” stored in the local data memory M0 is transferred to the local data memory M3 via the data bus b03.

After the completion of the data transfer, the special purpose function unit 00 informs the special purpose function unit φ3 of the completion of the transfer.

While the special purpose function unit φ3 is in operation and accessing to the local data memory M3, the data transfer controller 8 stores the request of the concerned data transfer temporarily, and controls not to execute the data transfer, until the processing by the special purpose function unit φ3 is completed and the local memory M3 is released.

On the contrary, when the code “not-coded” is not detected in the special purpose function unit φ0, the quantized DCT coefficient data stored in the local data memory M0 is transferred to the local data memory M1 via the data bus b01, under the control of the data transfer controller C01.

In case of this data transfer, the data transfer controller C01 performs arbitration with the DMA controller 3, in a similar manner as in Embodiment 1.

After the completion of the data transfer, the special purpose function unit φ0 sends a notice of the completion of the data transfer to the special purpose function unit φ1.

Upon receiving the notice, the inverse quantization circuit ω1 executes the inverse quantization process for the quantized DCT coefficient data stored in the local memory M1, and stores the resultant DCT coefficient data into the local memory M1.

The DCT coefficient data stored in the local memory M1 is transferred to the local memory M2 via the data bus b12, by the control of the data transfer controller C12.

In this data transfer, the data transfer controller C12 performs arbitration with the DMA controller 3, in a similar manner as in Embodiment 1.

After the completion of the data transfer, the special purpose function unit φ1 sends a notice of the completion of the data transfer to the special purpose function unit φ2.

Upon receiving the notice, the IDCT circuit ω2 executes the IDCT process for the DCT coefficient data stored in the local memory M2, and stores the resultant difference data into the local memory M2.

The difference data stored in the local memory M2 is transferred to the local memory M3 via the data bus b23, by the control of the data transfer controller C23.

In this data transfer, the data transfer controller C23 performs arbitration with the DMA controller 3, in a similar manner as in Embodiment 1.

The data transfer controller 23 also performs arbitration with the data transfer controller 8.

After the completion of the data transfer, the special purpose function unit φ2 sends a notice of the completion of the data transfer to the special purpose function unit φ3.

Upon receiving the notice, the motion compensation circuit ω3 executes the motion compensation process for the difference data stored in the local memory unit M3, and stores the resultant decoded moving image data into the local memory M3.

The decoded moving image data stored in the local data memory M3 is transferred to the main memory 1 via the data bus 4, and it is further transferred from the main memory 1 to the local data memory 22 of the processor 2, via the data bus 4, and then it is postprocessed. The decoding process described above is similar to the decoding process in Embodiment 1.

As described above, in Embodiment 1, the data buses b01, b12, b23, and b03, connecting the special purpose function units φ0˜φ3 under wired logic control, are provided.

With such a structure, the data transfer between the special purpose function unit φ0 and the special purpose function unit φ1 can be carried out via the data bus b01. The data transfer between the special purpose function unit φ1 and the special purpose function unit φ2 can be carried out via the data bus b12. The data transfer between the special purpose function unit φ2 and the special purpose function unit φ3 can be carried out via the data bus b23. And the data transfer between the special purpose function unit φ0 and the special purpose function unit φ3 can be carried out via the data bus b03.

As a result, the frequency of the data transfer via the data bus 4 can be suppressed Therefore, in executing a series of processing (a series of processing for decoding) by the processor 2, operable under program control, and by the special purpose function units φ0˜φ3, the waiting time for the data transfer can be suppressed.

As a result, the processing efficiency can increased independently of the number of the special purpose function units φ0˜φ3.

Furthermore, the flexibility in the data processing by the processor 2, operable under program control, and the reduction of electric power consumption by the special purpose function units φ0·φ3, operable under wired logic control, can be maintained.

In the present embodiment the data bus b performs unilateral data transfer among the special purpose function units 4.

Therefore, it is easier to control the data transfer than in the case of bilateral data transfer.

In the present embodiment the special purpose function unit φ0 is connected to the special purpose function units φ1 and φ3, in one-to-many correspondence, by the data buses b01 and b03.

Due to the above-mentioned structure, the result of the processing by the special purpose function unit φ0 can be transferred to a special purpose function unit selected from a plurality of the special purpose function units φ1 and φ3. As a result, the degree of freedom in data processing can be increased.

In a similar manner as in Embodiment 1, according to the completion of storing the result of the processing into the local data memory M, the special purpose function unit 4 requests the data transfer controller C to transfer the data.

As explained in Embodiment 1, the processor 2 can also request the data transfer controller C to transfer the data.

In a similar manner as in Embodiment 1, when the special purpose function unit φ completes the data transfer to other connected special purpose function units s, the special purpose function unit φ informs the other connected special purpose function units φ of the completion of the data transfer.

By a trigger of receiving the notice of the completion for data transfer from special purpose function units φ, the special purpose calculating circuits a) start and execute calculations in the other special purpose function units φ.

The special purpose calculating circuit ω can also be started by the control of the processor 2, in the same way as in Embodiment 1.

As mentioned above, the control of the data transfer among a plurality of the special purpose function units φ via the data bus b is executed by the data transfer controller C.

In a similar manner as explained in Embodiment 1, the control of the data transfer among a plurality of the special purpose function units φ via the data bus b is also executed by the processor 2.

In case that the processor 2 executes the control of the data transfer via the data bus b, the data transfer controller C becomes unnecessary and the reduction in the area of circuits to be packaged can be realized.

Furthermore, in this case, the data transfer among plural special purpose function units φ via the data bus b becomes possible to be program-controlled by the processing 2. As a result, the data transfer between the plural special purpose function units φ can be freely performed.

On the contrary, in case that the data transfer controller C performs the control of the data transfer via the data bus b, the load of the processor 2 can be reduced.

In the above case, the selection of the destination for the data transfer from the special purpose function unit φ0 is performed by the special purpose function unit φ0.

The selection of the destination for the data transfer from the special purpose function unit φ0 can be also performed by the processor 2. The point is explained referring to a concrete example.

Assume a data transfer from the special purpose function unit φ0 to the special purpose function unit φ1 or to the special purpose function unit φ3.

When the processing of variable length decoding in the special purpose function unit φ0 is completed and the storage of data into the local data memory M0 is completed, the special purpose function unit φ0 sends a notice of the completion of the processing of variable length decoding to the processor 2.

Upon receiving the notice, the processor 2 verifies, at the special purpose function unit φ0, the kind of the decoded codes.

When the decoded code is “not-coded”, the processor 2 verifies the status of the special purpose function unit φ3. If the data transfer is possible for the special purpose function unit φ3, the processor 2 sends, to the special purpose function unit φ0, a notice for the data transfer to the special purpose function unit φ3.

After receiving the notice, the special purpose function unit φ0 transfers the data “Y” stored in the local data memory M0 to the local data memory M3 via the data bus b03.

After the completion of the data transfer, the special purpose function unit 40 informs the processor 2 of the completion of data transfer.

When the decoded code is not “not-coded”, since the quantized DCT coefficient data exists, the processor 2 verifies the status of the special purpose function unit φ1. If the transfer of the decoded quantized DCT coefficient data is possible, the processor 2 sends, to the special purpose function unit φ0, a notice of the data transfer to the special purpose function unit φ1.

After receiving the notice of the data transfer, the special purpose function unit φ0 transfers the quantized DCT coefficient data stored in the local data memory M0 to the local data memory M1 via the data bus b01.

After the completion of the data transfer, the special purpose function unit φ0 sends a notice of the completion of the data transfer to the processor 2.

In this way, it is also possible that the selection of the destination for the data transfer from the special purpose function unit φ0 is made by the processor 2.

It has been so far explained that the processing of the moving image decoding corresponds to the inter frame decoding process.

The intra frame decoding process can also be performed in a similar manner as described above, by the sequence of the operations excluding the processing of the special purpose function unit φ3.

In the above explanation, the special purpose function unit φ comprises the special purpose calculating circuit (o to execute the decoding process.

However, the function of the special purpose calculating circuit ω is not limited to the above-mentioned function. The present embodiment can be applied to a special purpose calculating circuit ω with an arbitrary function.

In the above-mentioned case, it is assumed that the number of special purpose function unit φ is four, the number of data transfer controller C is four, and the number of data bus b is four. These numbers are not limited to this case but can be set arbitrarily. One data bus comprises a plurality of signal lines.

A combination of the present embodiment and Embodiment 1 can also be applied. Or a combination of the present embodiment and Embodiment 2 can also be applied.

(Embodiment 4)

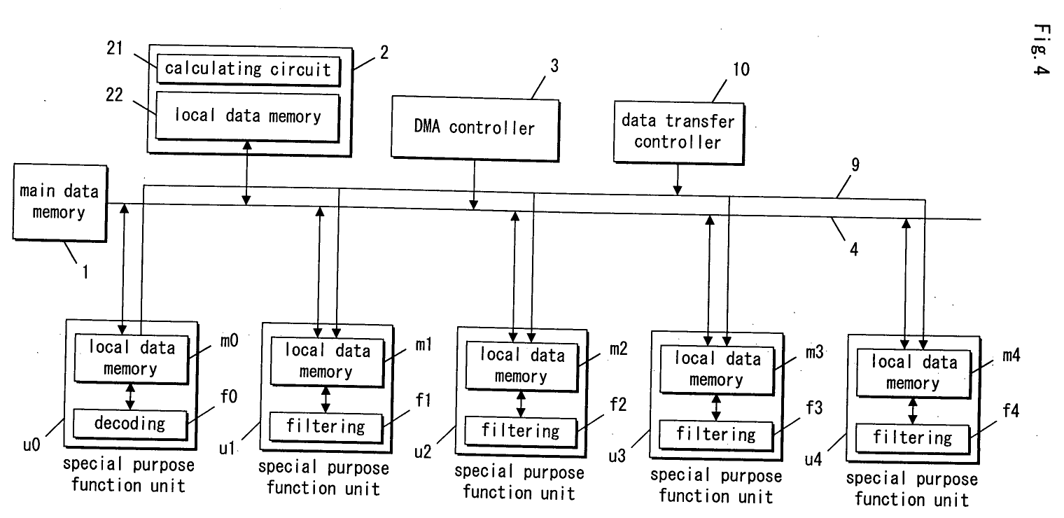

FIG. 4 shows a block diagram of a moving image processing apparatus according to Embodiment 4. In FIG. 4, the same units are labeled by the same symbols as in FIG. 1, and the explanation for these is omitted.

As shown in FIG. 4, the moving image processing apparatus comprises a main data memory 1, a processor 2, a direct memory access controller (DMA controller) 3, a special purpose function units u0˜u3, a data transfer controller 10, a data bus 4, and a data bus 9.

The processor 2 comprises a calculating circuit 21 and a local data memory 22. The special purpose function unit u0 comprises a local data memory m0 and a decoding circuit f0. The special purpose function unit u1 comprises a local data memory m1 and a filtering circuit f1. The special purpose function unit u2 comprises a local data memory m2, and a filtering circuit f2. The special purpose function unit u3 comprises a local data memory m3 and a filtering circuit f3. The special purpose function unit u4 comprises a local data memory m4 and a filtering circuit f4. The moving image processing apparatus corresponds to the data processing system. The processor 2 corresponds to the data processing apparatus operable to execute the data processing under program control.

Each of special purpose function units u0˜u4 corresponds to the data processing apparatus (a data processing apparatus consisting of the special purpose hardware specialized to a designated function) to execute the data processing under wired logic control.

The special purpose function units u0˜u4 are collectively expressed as a special purpose function unit U.

The local data memories m0˜m4 are collectively expressed as a local data memory m.

The decoding circuit f0 and the filtering circuits f1˜f4 are collectively expressed as a special purpose calculating circuit f.

The function and the operation for each unit as shown in FIG. 1 are simply described. The main data memory 1 stores the data. For example, the main data memory 1 stores the resultant data of the processing by the processor 2 or the resultant data of the processing by the special purpose function units u0˜u4.

The processor 2 executes the data processing under program control. The local data memory 22 of the processor 2 stores the data transferred from the main data memory 1 or the resultant data of the processing by the calculating circuit 21.

The calculating circuit 21 of the processor 2 carries out data manipulation or calculation ordered by the instructions. For example, the calculating circuit 21 executes a calculating operation for the data, transferred from the min data memory 1 and stored in the local data memory 22, and stores the resultant data into the local data memory 22.

The local data memory m0 of the special purpose function unit u0 stores the data transferred from the main data memory 1 or the resultant processed data by the decoding circuit f0.

The decoding circuit f0 of the special purpose function unit u0 performs the decoding of the data stored in the local data memory m0, and stores the result (decoded moving image data) into the local data memory m0.

To put it more concretely, the decoding circuit f0 decodes the decoding target encoded data, encoded by an MPEG system, and stores the resultant decoded moving image data into the local data memory m0.

The local data memories m1˜m4 of the special purpose function units u1 u4 store the data transferred from the main data memory 1 or the result of decoding (decoded moving image data) by the decoding circuit f0.

The filtering circuits f1˜f4 of the special purpose function units u4 perform the filtering operation for the data stored in the corresponding local data memories m1˜m4, and store the corresponding result into the corresponding local data memories m1˜m4, respectively.

The DMA controller 3 controls the data transfer between the main data memory 1 and the local data memory 22, or the data transfer between the main data memory 1 and the local data memories m0˜m4.

The data bus 4 connects the processor 2 and the special purpose function units u0˜u4, via the main data memory 1.

The data transfer between the main data memory 1 and the processor 2 or the data transfer between the main data memory 1 and the special purpose function units u0˜u4 are performed via the data bus 4.

The data transfer controller 10 controls the data transfer from the local data memory m0 of the special purpose function unit u0 to the local data memories m1˜m4 of the special purpose function units u0˜u4.

The data bus 9 connects the special purpose function unit u0 and the special purpose function units u1˜u4, and performs the data transfer from the special purpose function unit u0 to the special purpose function units u0˜u4.

The filtering circuits f1˜f4 are described in detail. Each of the filtering circuits f1˜f4 executes the filtering processing to reduce noises in the decoded moving image that is decoded from the encoded image data by the MPEG system.

In the MPEG system, spatial correlation among the blocks in the same frame is lost, since the encoding is performed per block consisting of 8 pixels×8 pixels.

As a result, the boundary of the block becomes like discontinued mosaic patterns. This noise is called block noise.

As one of the methods of removing the block noise, a new block including the pixels on the boundary of the adjacent block is filtered.

In the processing of removing the block noise by the method described above, all the blocks constituting one flame need to be filtered, and a large amount of the processing is needed.

In the present embodiment, focusing to the fact that parallel processing is possible in the present embodiment, four special purpose function units u1˜u4 are provided to execute filtering operations for four blocks simultaneously. In this way, a high speed processing in filtering is.

The processing flow for the moving image processing apparatus according to Embodiment 4 is described.

First, upon instructed by the processor 2, the DMA controller 3 transfers the decoding target encoded data stored in the main data memory 1 to the local data memory m0 of the special purpose function unit u0, via the data bus 4.

The concrete processing in this case is similar to the decoding process in Embodiment 1, as shown in FIG. 1, where the DMA controller 3, upon instructed by the processor 2, transfers the decoding target encoded data stored in the main data memory 1 to the local data memory M0 of the special purpose function unit U0 via the data bus 4, as shown in FIG. 1.

When the above-mentioned data transfer completed, the processor 2 receives, from the DMA controller 3, a notice of the completion of the data transfer.

After receiving the notice, the processor 2 instructs the special purpose function unit u0 to start the signal processing.

The decoding circuit f0 of the special purpose function unit u0, having received the instruction, executes the decoding processing for the decoding target encoded data stored in the local data memory m0, and stores the resultant decoded moving image data into the local data memory m0.

Then, the decoded moving image data stored in the local data memory m0 is transferred to the local data memories m1 m4 of the special purpose function units u0˜u4, via the data bus 9. To put it concretely, the data transfer is executed as follows.

Responding to the completion of the storage of the decoded moving image data into the local data memory m0, the special purpose function unit u0 issues a request of the data transfer to the data transfer controller 10.

If the special purpose function units u1˜u4 are ready for receiving the data, the data transfer controller 10 transfers the decoded moving image data stored in the local data memory m0 to the local data memories m1˜m4 via the data bus 9. The unit of the data transfer in this case is per block.

Therefore, the data per unit of block is inputted and stored in each of the local data memories m1˜m4, respectively.

After the completion of the data transfer, the special purpose function units u0 informs each of the special purpose function units u1˜u4 of the completion of the data transfer.

Having received the notice of the completion, the filtering circuits f1˜f4 of the special purpose function units u1˜u4 starts the filtering process for the block data stored in the corresponding local data memories m1˜m4.

Then, the filtering circuits f1˜f4 store the resultant data after the filtering process into the corresponding local data memories m1˜m4.

After the completion of the filtering process, the special purpose function units u1˜u4 inform the processor 2 of the completion of the filtering process.

Upon receiving the notice, the processor 2 transfers the filtered decoded moving image data stored in the local data memories m1˜m4, to the main data memory 1.

On this occasion, the processor 2 executes a series of instructions to transfer the filtered decoded moving image data, stored in the local data memories m1˜m4, to the main data memory 1 and issues a request of the data transfer to the DMA controller 3.

The DMA controller 3 performs arbitration between the concerned request of the data transfer and other requests of data transfer via data bus 4, and finally executes the data transfer from the local data memories m1˜m4 to the main data memory 1, after accepting the concerned request of the data transfer by the processor 2.

The path for this data transfer is a path leading to the main data memory 1 from the local data memories m1˜m4 via the data bus 4.

As described above, since the data bus 9 connecting the special purpose function units u1˜u4 operable under wired logic control is provided in the present embodiment, the data transfer from the special purpose function unit u0 to the special purpose function units u1˜u4 can be executed via the data bus 9.

For this reason, the frequency of the data transfer via the data bus 4 can be suppressed. Therefore, in case of executing a series of processing (a series of processing pertaining to decoding) by the processor 2 operable under program control and by the special purpose function units u0˜u4, the waiting time for the data transfer can be suppressed.

As a result, the efficiency for data processing can be increased, independently of the number of the special purpose function units u0˜u4.

Furthermore, the flexibility in the data processing by the processor 2 operable under program control, and the reduction of electric power consumption by the special purpose function units u0˜u4, operable under wired logic control, can be maintained.

In the present embodiment, the data bus 9 performs unilateral data transfer between the special purpose function unit u0 and the special purpose function units u1˜u4.

Therefore, it is easier to control the data transfer than in the case of bilateral data transfer.

In the present embodiment, the special purpose function unit u0 is connected to the special purpose function units u1˜u4 via the data bus 9. Furthermore, a unilateral data transfer from the special purpose function unit u0 to the special purpose function units u1˜u4 is performed via the data bus 9.

With such a structure, the special purpose function units u1˜u4 can execute in parallel the filtering process for the resultant decoded moving image data of the special purpose function unit u0. As a result, the high speeding in the processing can be realized.

In the case described above, when the data transfer to the special purpose function units u1˜u4 is completed, the special purpose function unit u0 informs the special purpose function units u1˜u4 of the completion of the data transfer.

By a trigger of receiving the notice of the completion for data transfer from special purpose function units u0, the filtering circuits f1˜f4 of the special purpose function units u1˜u4 start to execute the filtering process.

The filtering circuits f1˜f4 can also be started by the control of the processor 2, in a similar manner as explained in Embodiment 1.

In the above-mentioned case, responding to the completion of storing the resultant data into the local data memory m0, the special purpose function unit u0 issues, to the data transfer controller 10, a request of the data transfer.

The processor 2 can also issue, to the data transfer controller 10, the request of the data transfer, in a similar manner as explained in Embodiment 1.

In the above-mentioned case, the control of the data transfer to the special purpose function units u1˜u4 from the special purpose function unit u0 via data bus 9 is performed by the data transfer controller 10.

However, the processor 2 can also perform the control of the data transfer, in a similar manner as explained in Embodiment 1.

In case that the processor 2 performs the data transfer via the data bus 9, the data transfer controller 10 becomes unnecessary. Therefore, the reduction in the area of circuits to be packaged can be realized.

Furthermore, in this case, the data transfer via the data bus 9 among the special purpose function units u0˜u4 becomes possible to be program-controlled by the processing 2. As a result, the data transfer among the special purpose function units u0˜u4 ca be freely performed.

In case of the data transfer controller 10 performing the control of the data transfer via data bus 9, the load of the processor 2 can be reduced.

In the case described above, the special purpose function unit u0 comprises the decoding circuit f0 to perform the decoding process, and the special purpose function units u1˜u4 comprise the filtering circuits f1˜f4 to perform the filtering process.

However, the function of the special purpose filtering circuit f of the special purpose function unit u is not limited to the example described above, and the present embodiment can be applied to a special purpose filtering circuit f with an arbitrary function.

In the case described above, the unilateral data transfer from the special purpose function units u0 to the special purpose function units u1˜u4 is performed. According to the function of the special purpose filtering circuit f of the special purpose function unit u, the data transfer in an arbitrary direction between any of the special purpose function units u can be performed via the data bus 9.

As described above, provided that the data transfer in an arbitrary direction between any of the special purpose function units u is possible, various kinds of processing can be performed just by changing the special purpose function unit u, without changing hardware structure of the data transfer controller 10, which controls the data transfer via data bus 9.

In the case described above, it is assumed that the number of special purpose function units u1˜u4 is four. The number of the special purpose function units is not limited to the case, but can be arbitrarily changed.

The present embodiment can be combined with Embodiments 1˜3.

(Embodiment 5)

The whole structure of the moving image encoding/decoding apparatus according to Embodiment 5 is the same as the whole structure of the moving image encoding/decoding apparatus shown in FIG. 1.

Therefore, in the explanation of Embodiment 5, the moving image encoding/decoding apparatus shown in FIG. 1 is explained as the moving image encoding/decoding apparatus of Embodiment 5.

However, in the moving image encoding/decoding apparatus according to Embodiment 5, other special purpose function units are provided in stead of the special purpose function units U1 and U2 shown in FIG. 1. This point is explained in detail.

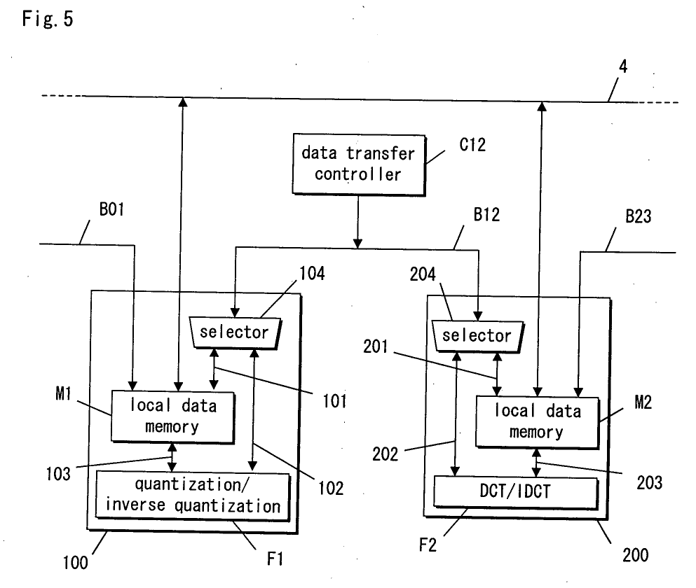

FIG. 5 shows a block diagram of a main part of the moving image encoding/decoding apparatus according to Embodiment 5. In FIG. 5, the same components as in FIG. 1 are labeled with the same symbols as in FIG. 1.

As shown in FIG. 5, the moving image encoding/decoding apparatus according to the present embodiment provides a special purpose function unit 100 in stead of the special purpose function unit U1 shown in FIG. 1, and a special purpose function unit 200 in stead of the special purpose function unit U2 shown in FIG. 1. In the following, an explanation is made focusing on different features from Embodiment 1.

As shown in FIG. 5, the special purpose function unit 100 comprises a local data memory M1, a quantization/inverse quantization circuit F1, a selector 104, and data buses 101, 102, and 103.

The special purpose function unit 200 comprises a local data memory M2, a discrete cosine transform/inverse discrete cosine transform circuit (DCT/IDCT circuit) F2, a selector 204, and data buses 201, 202, and 203.

The data bus B01 connects the local data memory M0 of the special purpose function unit U0 shown in FIG. 1 to the local data memory M1 of the special purpose function unit 100.

The data bus 103 connects the local data memory M1 to the quantitation/inverse quantization circuit F1.

The data bus 102 connects the quantization/inverse quantization circuit F1 to the data bus B12 via the selector 104.

The data bus 101 connects the local data memory M1 to the data bus B12 via the selector 104.

The data bus B12 connects the selector 104 of the special purpose function unit 100 to the selector 204 of the special purpose function unit 200.

The data bus 201 connects the local data memory M2 to the data bus B12 via the selector 204.

The data bus 202 connects the DCT/IDCT circuit F2 to the data bus B12 via the selector 104.

The data bus 203 connects the local data memory M2 to the DCT/IDCT circuit F2.

The data bus B23 connects the local data memory M2 of the special purpose function unit 200 to the local data memory M3 of the special purpose function unit U3 shown in FIG. 1.

The selector 104 of the special purpose function unit 100 selects either the data bus 101 or the data bus 102, and connects the selected data bas to the data bus B12.

The selector 204 of the special purpose function unit 200 selects either the data bus 201 or the data bus 202, and connects the selected data bas to the data bus B12.

The operation in encoding and decoding for the moving image is described. First, the operation in encoding is described. The encoding process in this case is one by MPEG system, for example.

The processing up to where the difference data is transferred to the local data memory M2 of the special purpose function unit 200 via the data bus B23, is the same as the process up to where the difference data is transferred to the local data memory M2 of the special purpose function unit U2 via the data bus B23, in the encoding process according to Embodiment 1.

Synchronizing with a designated clock, the difference data is continuously inputted from the local data memory M2 to the DCT/IDCT circuit F2 of the special purpose function unit 200.

The DCT/DCT circuit F2 can perform the discrete cosine transform process for each difference data.

The DCT/IDCT circuit F2 is a synchronized circuit, operating in synchronization with the designated clock. The DCT/DCT circuit F2 inputs one difference data in one cycle of the designated clock, executes the processing of the discrete cosine transform for the one difference data in several cycles, and outputs one DCT coefficient data in one cycle.

Therefore, each of the resultant DCT coefficient data is continuously outputted from the DCT/DCT circuit F2 to the data bus 202, after the delay of several cycles from the start of the processing, synchronized with the clock.

In this case, the selector 204 selects the data bus 202, and connects the data bus B12 and the data bus 202.

Therefore, each DCT coefficient data from the DCT/IDCT circuit F2 is continuously outputted to the data bus B12 via the data bus 202, synchronizing with the designated clock described above.

In this case, the selector 104 of the special purpose function unit 100 selects the data bus 102, and connects the data bus B12 and the data bus 102.

Therefore, each DCT coefficient data from the DCT/DCT circuit F2 is inputted to the data bus 102 via the data buses 202 and B12, synchronizing with the designated clock described above.

The quantization/inverse quantization circuit F1 can execute the processing of the quantization for each DCT coefficient data.

The quantization/inverse quantization circuit F1 is a synchronized circuit, operating in synchronization with the designated clock. The quantization/inverse quantization circuit F1 inputs one DCT coefficient data in one cycle of the designated clock, executes the processing of the quantization for one DCT coefficient data in one cycle, and outputs one quantized DCT coefficient data in one cycle.

Therefore, the quantization/inverse quantization circuit F1 executes sequentially the processing of the quantization for each of the DCT coefficient data, continuously inputted in synchronization with the designated clock.

The quantization/inverse quantization circuit F1 outputs the resultant quantized DCT coefficient data to the data bus 103, synchronizing with the clock, and then stores the quantized DCT coefficient data into the local data memory M1.

In the processing described above, the path, leading to the local data memory M1 of the special purpose function unit 100 from the local data memory M2 of the special purpose function unit 200, is a path from the local data memory M2, the data bus 203, the DCT/IDCT circuit F2, the data bus 202, the selector 204, the data bus B12, the selector 104, the data bus 102, the quantization/inverse quantization circuit F1, the data bus 103, and to the local data memory M1.

The processing after storing the quantized DCT coefficient data in the local data memory M1 of the special purpose function unit 100 is the same as the processing after storing the quantized DCT coefficient data in the local data memory M1 of the special purpose function unit U1, in the encoding processing according to Embodiment 1.

Next, a flow of the processing from the DCT/IDCT circuit F2 to the quantization/inverse quantization circuit F1 is described in detail, referring to a timing chart.

First, the flow of the processing via the local data memories M1 and M2 is described. Although this processing is different from the above-mentioned processing, this processing is explained, in order to make it easier to understand the effect of the above-mentioned processing.

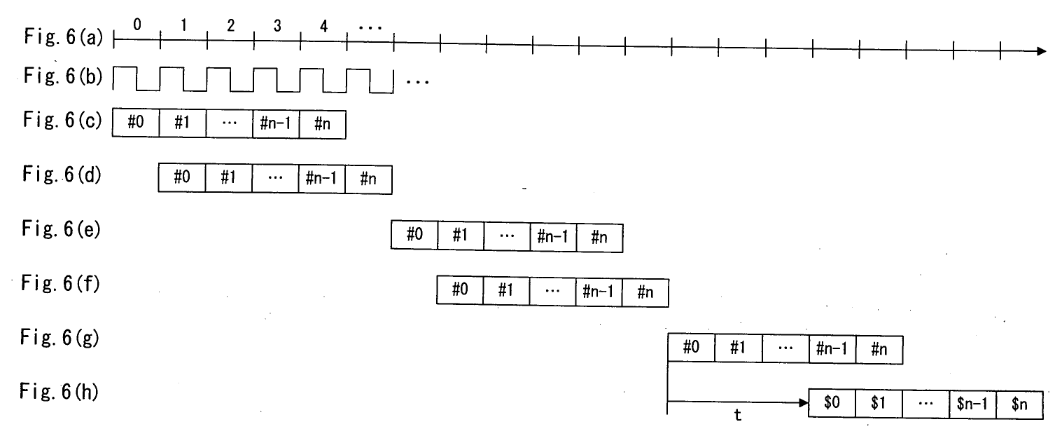

FIG. 6 shows a timing chart of the processing by the moving image encoding/decoding apparatus according to Embodiment 5, passing through the local data memories. FIG. 6(a) shows a time axis, where one segment indicates one cycle.

FIG. 6(b) shows a designated clock, with which the DCT/IDCT circuit F2 and the quantization/inverse quantization circuit F1 operate in synchronization.

FIG. 6(c) shows a timing chart where the DCT coefficient data #0, #1, . . . , #n (n is an integer) is outputted from the DCT/IDCT circuit F2 to the data bus 203.

FIG. 6(d) shows a timing chart where the DCT coefficient data #0, #1, . . . , #n is stored into the local data memory M2.

FIG. 6(e) shows a timing chart where the DCT coefficient data #0, #1, . . . , #n is transferred from the local data memory M2 of the special purpose function unit 200 to the local data memory M1 of the special purpose function unit 100.

FIG. 6(f) shows a timing chart where the DCT coefficient data #0, #1, . . . , #n is stored into the local data memory M1 of the special purpose function unit 100.

FIG. 6(g) shows a timing chart where the DCT coefficient data #0, #1, . . . , #n is read out from the local data memory M1.

FIG. 6(h) shows a timing chart where the quantized DCT coefficient data $0, $1, . . . , $n (n is an integer) is outputted from the quantization/inverse quantization circuit F1 to the data bus 103.

The DCT/IDCT circuit F2 operates in synchronization with the clock shown in FIG. 6(b), and executes the processing of the discrete cosine transform for one difference data in several cycles of the clock.

As shown in FIG. 6(c), the DCT/IDCT circuit F2 outputs one DCT coefficient data to the data bus 203 in one cycle of the clock.

Therefore, as shown in FIG. 6(c), the DCT/IDCT circuit F2 outputs continuously the DCT coefficient data #0, #1, . . . , #n to the data bus 203, in synchronization with the clock.

In the DCT/IDCT circuit F2, each of the processing of the input of the difference data, the discrete cosine transform, and the output of the DCT coefficient data is executed by pipeline process.

As shown in FIGS. 6(c) and (d), in the special purpose function unit 200, the DCT coefficient data #N (N=0, 1, . . . , n−1), outputted to the data bus 203 at a certain cycle, is stored into the local data memory M2 at the next cycle, and the DCT coefficient data #N+1 is outputted to the data bus 203 at the same next cycle.

When all of the DCT coefficient data #0˜#n complete to be stored into the local data memory M2, the special purpose function unit 200 informs the data transfer controller C12 of the completion of the storing.

Upon receiving the notice of the completion, the data transfer controller C12 transfers, synchronizing with the clock, the DCT coefficient data #0˜#n to the local data memory M1 via the data buses 201, B12, and 101, as shown in FIG. 6(e).

In this case, the selector 204 selects the data bus 201, and connects the data bus 201 and the data bus B12. The selector 104 selects the data bus 101, and connects the data bus 101 and the data bus B12.

As shown in FIGS. 6(e) and (t), the DCT coefficient data #N (N=0, 1, . . . , n−1), outputted to the data bus 201 at a certain cycle, is stored into the local data memory M1 at the next cycle, and the DCT coefficient data #N+1 is outputted to the data bus 201 at the same next cycle.

When the data transfer completes for the entire DCT coefficient data #0˜#n from the local data memory M2 to the local data memory M1, the quantization/inverse quantization circuit F1 is started in order to execute the processing of the quantization.

As shown in FIG. 6(g), the DCT coefficient data #0˜#n is read out from the local data memory M1, according to the clock.

As shown in FIG. 6(h), after a lapse of time t from the beginning of the read-out of the DCT coefficient data from the local data memory M1, the quantization/inverse quantization circuit F1 outputs the quantized DCT coefficient data $0˜$n (n is an integer), as the result of quantization processing, to the data bus 103. The time t is the latency of the quantization/inverse quantization circuit F1.

In the quantization/inverse quantization circuit F1, each of the processing of the input of the DCT coefficient data, the quantization, and the output of the DCT coefficient data is executed by pipeline process.

Next, the flow of processing not using the local data memories M1 and M2 is described

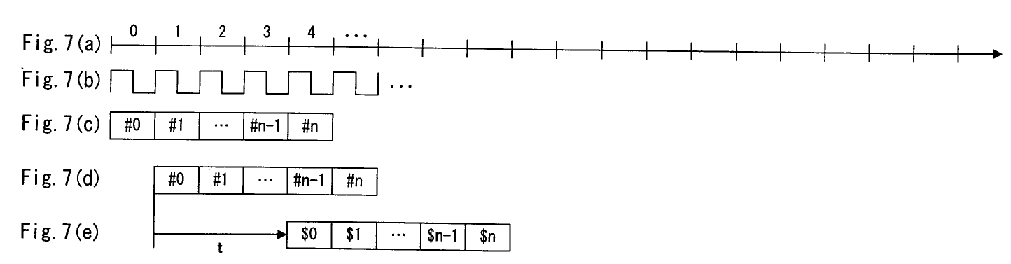

FIG. 7 shows a timing chart of the processing by the moving image encoding/decoding apparatus according to Embodiment 5, not passing through the local data memories.

FIG. 7(a) shows a time axis, where one segment indicates one cycle.

FIG. 7(b) shows a designated clock, with which the DCT/DCT circuit F2 and the quantization/inverse quantization circuit F1 operate in synchronization.

FIG. 7(c) shows a timing chart where the DCT coefficient data #0, #1, . . . , #n (n is an integer) is outputted from the DCT/DCT circuit F2 to the data bus 202.

FIG. 7(d) shows a timing chart where the DCT coefficient data #0, #1, . . . , #n is transferred to the quantization/inverse quantization circuit F1 of the special function unit 100, via the data buses 202, B12, and 102.

FIG. 7(e) shows a timing chart where the quantized DCT coefficient data $0, $1, . . . ,$n (n is an integer) is outputted from the quantization/inverse quantization circuit F1 to the data bus 103.

The DCT/IDCT circuit F2 operates in synchronization with the designated clock and executes the processing of the discrete cosine transform for one difference data in several cycles of the clock.

As shown in FIG. 7(c), the DCT/IDCT circuit F2 outputs one DCT coefficient data to the data bus 202 in one cycle of the clock.

Therefore, as shown in FIG. 7(c), the DCT/IDCT circuit F2 outputs continuously the DCT coefficient data #0˜#n to the data bus 202, according to the clock.

In the DCT/IDCT circuit F2, each of the processing of the input of the difference data, the discrete cosine transform, and the output of the DCT coefficient data is executed by pipeline process.

As shown in FIGS. 6(c) and (d), the DCT coefficient data #N (N=0, 1, . . . , n−1), outputted to the data bus 202 at a certain cycle, is transferred to the quantization/inverse quantization circuit F1 of the special purpose function unit 100 via the data buses 202, B12, and 102 at the next cycle, and the DCT coefficient data #N+1 is outputted to the data bus 202 at the same next cycle.

In this way, the DCT coefficient data is continuously inputted to the quantization/inverse quantization circuit F1, according to the clock.

In this case, the selector 204 selects the data bus 202, and connects the data bus 202 and the data bus B12. The selector 104 selects the data bus 102, and connects the data bus 102 and the data bus B12.

As shown in FIG. 7(e), after a lapse of time t from the input of the DCT coefficient data to the quantization/inverse quantization circuit F1, the quantization/inverse quantization circuit F1 outputs the resultant quantized DCT coefficient data $0˜$n to the data bus 103. The time t is the latency of the quantization/inverse quantization circuit F1.

In the quantization/inverse quantization circuit F1, each of the processing of the input the DCT coefficient data, the quantization, and the output of the DCT coefficient data is executed by pipeline process.

As described above, due to the pipeline process in the DCT/IDCT circuit F2 and the quantization/inverse quantization circuit F1, the DCT coefficient data can be executed for quantization, by directly and continuously inputting from the DCT/IDCT circuit F2 to the quantization/inverse quantization circuit F1 via the data buses 202, B12, and 102.

For the above-mentioned reason, the storing in the local data memory M2, the read-out from the local data memory M2, the storing in the local data memory M1, and the read-out from the local data memory M1 can be omitted. Therefore, the efficiency of the encoding process can be improved.

It is clear from the comparison of FIG. 6 and FIG. 7 that the processing time for the processing without a path through the local data memories M1 and M2 (FIG. 7) is shorter.

Next, the operation of executing the decoding process is described. In this case, the decoding process is, for example, a processing corresponding to the MPEG system.

The processing up to where the quantized DCT coefficient data is transferred to the local data memory M1 of the special purpose function unit 100 via the data bus B01, is the same as the process up to where the quantized DCT coefficient data is transferred to the local data memory M1 of the special purpose function unit U1 via the data bus B04, in the decoding process according to Embodiment 1.

Synchronizing with the clock, the quantized DCT coefficient data is continuously inputted from the local data memory M1 to the quantization/inverse quantization circuit F1 of the special purpose function unit 100.

The quantization/inverse quantization circuit F1 can perform the processing of the inverse quantization for each quantized DCT coefficient data.

The quantization/inverse quantization circuit F1 is a synchronized circuit, operating in synchronization with the designated clock described above. The quantization/inverse quantization circuit F1 inputs one quantized DCT coefficient data in one cycle of the clock, executes the processing of the inverse quantization for one quantized DCT coefficient data in several cycles, and outputs one DCT coefficient data in one cycle.

Therefore, from the quantization/inverse quantization circuit F1, each resultant DCT coefficient data is continuously outputted to the data bus 102, in synchronization with the clock, after the delay of several cycles from the start of the processing.

In this case, the selector 104 selects the data bus 102, and connects the data bus B12 and the data bus 102.

Accordingly, each DCT coefficient data from the quantization/inverse quantization circuit F1 is continuously outputted to the data bus B12 via the data bus 102, in synchronization with the designated clock described above.

In this case, the selector 204 of the special purpose function unit 200 selects the data bus 202, and connects the data bus B12 and the data bus 202.

Accordingly, each DCT coefficient data from the quantization/inverse quantization circuit F1 is inputted to the data bus 202 via the data buses 102 and B12, according to the clock.

In the quantization/inverse quantization circuit F1, each of the processing of the input of the DCT coefficient data, the inverse quantization, and the output of the DCT coefficient data is executed by pipeline process.

The DCT/IDCT circuit F2 can execute the processing of inverse cosine transform (IDCT) for each of the DCT coefficient data.

Furthermore, the DCT/DCT circuit F2 is a synchronized circuit, operating in synchronization with the designated clock. The DCT/IDCT circuit F2 inputs one quantized DCT coefficient data in one cycle of the clock, executes the processing of the inverse discrete cosine transform for one DCT coefficient data in several cycles, and outputs one difference data in one cycle.

Therefore, the DCT/IDCT circuit F2 executes sequentially the processing of the inverse discrete cosine transform (DCI) for each of the DCT coefficient data, inputted from the data bus 202, continuously at every cycle of the clock.

The DCT/IDCT circuit F2 outputs the resultant difference data to the data bus 203, according to the clock described above. The difference data is stored into the local data memory M2.

In the DCT/IDCT circuit F2, each of the processing of the input of the DCT coefficient data, the inverse discrete cosine transform, and the output of the difference data is executed by pipeline process.

In the above-described processing, the path from the local data memory M1 of the special purpose function unit 100 to the local data memory M2 of the special purpose function unit 200 is a path from the local data memory M1, the data bus 103, the quantization/inverse quantization circuit F1, the data bus 102, the selector 104, the data bus B12, the selector 204, the data bus 202, the DCT/IDCT circuit F2, the data bus 203, and to the local data memory M2.

The processing after storing the difference data into the local data memory M2 of the special purpose function unit 200 is the same as the processing after storing the difference data in the local data memory M2 of the special purpose function unit U2 according to Embodiment 1.

The timing chart of the decoding process via the local data memories M1 and M2 is the same as shown in FIG. 6, except that the special purpose function units 100 and 200 replaces each other.

The timing chart of the decoding process not passing through the local data memories M1 and M2 is the same as shown in FIG. 7, except that the special purpose function units 100 and 200 replaces each other.

When the data that is transferred to the local data memory M1 via the data buses 4 and B01, is transferred to the special purpose function unit 200 via the data bus B12, and when the data that is transferred from the data bus 12, is stored into the local data memory M1, the selector 104 selects the data bus 101, and connects the data bus 101 and the data bus B12.

When the data that is transferred to the local data memory M2 via the data buses 4 and B23, is transferred to the special purpose function unit 100 via the data bus B12, and when the data that is transferred from the data bus B12, is stored into the local data memory M2, the selector 204 selects the data bus 201, and connects the data bus 201 and the data bus B12.

As described above, the present embodiment comprises the same configuration as in Embodiment 1. For this reason, the present embodiment can improve the efficiency of the data processing, while maintaining flexibility of data processing under program control and reduction of the electric power consumption. Furthermore, the present embodiment has the same effects as in Embodiment 1.

In the present embodiment, in case that the DCT/IDCT circuit F2 executes the processing for the result processed by the quantization/inverse quantization circuit F1, and in case that the quantization/inverse quantization circuit F1 executes the processing for the result processed by the DCT/IDCT circuit F2, the selector 104 selects the data bus 102 and connects it to the data bus B12, and the selector 204 selects the data bus 202 and connects it to the data bus B12.

In this way, by providing the data buses 102 and 202 that connect directly the quantization/inverse quantization circuit F1 and the DCT/IDCT circuit F2, the resultant data of the quantization/inverse quantization circuit F1 can be directly inputted to the DCT/IDCT circuit F2 via the data bus B12, without storing the resultant data into the local data memory M1 temporarily.

For this reason, the processing of the quantization/inverse quantization circuit F1 and the processing of the DCT/IDCT circuit F2 for the result of the quantization/inverse quantization circuit F1 can be executed in parallel.

Similarly, the processing of the DCT/IDCT circuit F2 and the processing of the quantization/inverse quantization circuit F1 for the result of the DCT/IDCT circuit F2 can also be executed in parallel. As a result a high speeding of the processing is can be realized.

In the case described above, the special purpose function unit 100 is furnished with the quantization/inverse quantization circuit F1, and the special purpose function unit 200 is furnished with the DCT/IDCT circuit F2.

However, the function of the special purpose function unit F is not limited to the case stated above. The present embodiment can also be applied to a special purpose function unit F furnished with an arbitrary function.

The present embodiment and Embodiments 1 to 4 can also be combined with each other.

(Embodiment 6)

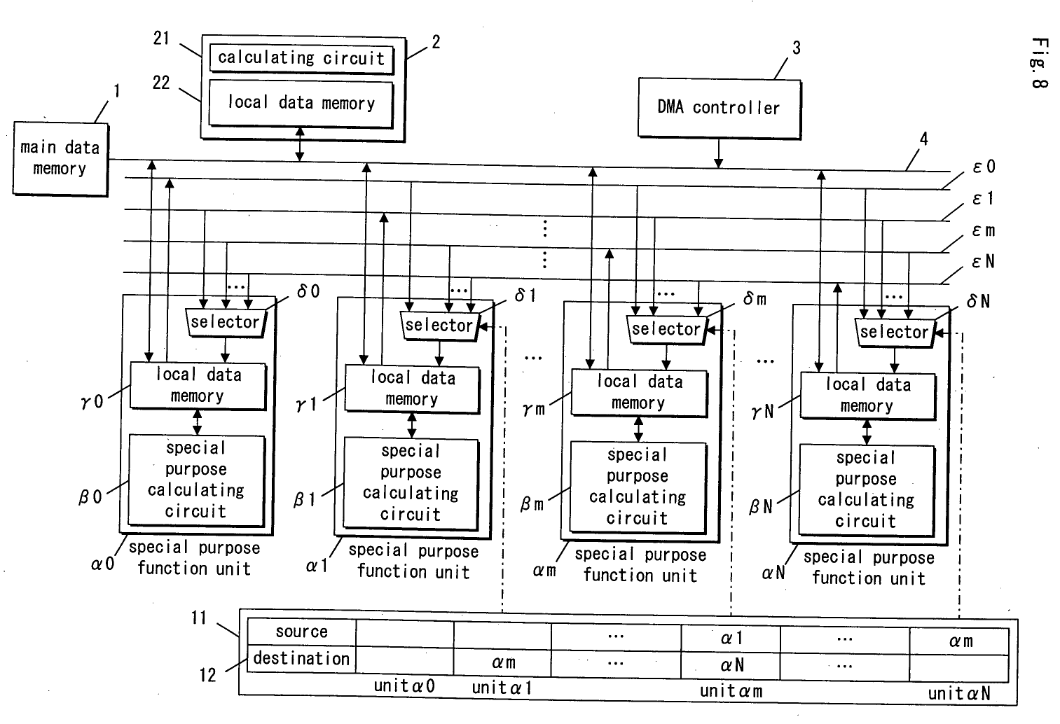

FIG. 8 shows a block diagram of a data processing system according to Embodiment 6. In FIG. 8, the same units are labeled by the same symbols as in FIG. 1, and the explanation for these is omitted.

As shown in FIG. 8, the data processing system comprises a main data memory 1, a processor 2, a direct memory access controller (DMA controller) 3, a special purpose function units α0˜αN (N is an integer equal to or g ta unity), a data bus 4, and data buses ε0˜εN (N is an integer equal to or greater than unity).

The processor 2 comprises a calculating circuit 21 and a local data memory 22. The special purpose function units α0˜αN comprise selectors δ0˜δN (N is an integer equal to or greater than unity), local data memories γ0˜γN, and special purpose calculating circuits β0˜βN (N is an integer equal to or greater than unity).

The processor 2 corresponds to the data processing unit to execute the data processing under program control.

Each of the special purpose function units α0˜αN corresponds to the data processing unit (a data processing unit consisting of a special purpose hardware specialized to a designated function) to execute the data processing under wired logic control.

The special purpose function units are collectively expressed as a special purpose function unit α. The data buses ε˜εN are collectively expressed as a data bus ε.

The selectors δ0˜δN are collectively expressed as a selector δ, the local data memories γ0˜γN are collectively expressed as a local memory 7, and the special purpose calculating circuits β0˜βN are collectively expressed as a special purpose calculating circuit β.

The data bus 4 connects the processor 2 to the special purpose function units α0˜αN via the main data memory 1.

One arbitrary data bus ε connects the local data memory γ of the corresponding special purpose function unit α to the selector δ of all the other special purpose function unit α, except the corresponding special purpose function unit α.

For example, the data bus εN connects the local data memory γN of the corresponding special purpose function unit αN to the selectors δ0˜δN−1 of all the other special purpose function units α0˜αN−1 except the corresponding special purpose function unit αN.

The operation of each unit is described. The main data memory 1 stores the data. For example, the main data memory 1 stores the result of the processing in the processor 2 or the result of the processing in the special purpose function unit a.

The processor 2 executes the data processing under program control. The local data memory 22 of the processor 2 stores the data transferred from the main data memory 1 or the result of the processing in the calculating circuit 21.

The calculating circuit 21 executes data manipulation or calculation ordered by the instructions. For example, the calculating circuit 21 performs the processing of operating for the data, transferred from the main data memory 1 and stored in the local data memory 22, and stores the result of processing into the local data memory 22.

The local data memory γ of the special purpose function unit a stores the data transferred from the main data memory 1 or the result of the processing in the corresponding special purpose calculating circuit β.

The special purpose calculating circuit β of the special purpose function unit a performs the predetermined calculation for the data stored in the corresponding local data memory γ, and then stores the result into the corresponding local data memory γ.

The DMA controller 3 controls the data transfer between the main data memory 1 and the processor 2, and the data transfer between the main data memory 1 and the special purpose function unit α.

The data bus ε performs the data transfer from the corresponding special purpose function unit α to the other special purpose function unit α.

For example, the data bus εN transfers the data, stored in the local data memory γ of the corresponding special purpose function unit αN, to the selected special purpose function unit of the other special purpose function units α0˜αN−1.

The selector δ selects one channel of the data bus of the connected data bus of N−1 channels, and connects it to the corresponding local data memory γ.

For example, after selecting one channel of the data buses ε0˜εN of the connected data bus of N−1 channels, the selector δN connects it to the corresponding local data memory γN.

A link map table 12 is stored in the register 11. The link map table 12 is a table to specify a special purpose function unit a as the source of the data transfer and another special purpose function unit a as the destination of the data transfer, for the special purpose function unit α.

Therefore, the selector δ practically connects the special purpose function unit α as the source of the data transfer to the special purpose function unit a as the destination of the data transfer, according to the link map table 12.

The practical connection means that the local data memory γ of the special purpose function unit α as the source of the data transfer is connected to the local data memory γ of the special purpose function unit a as the destination of the data transfer, and does not mean that the local data memory γ of the special purpose function unit a is simply connected to the selector δ of the other special purpose function unit a.

The processor 2 can rewrite the content of the link map table 12 in the register 11. Namely, the processor 2 can set the content of the link map table 12 arbitrarily.

To put it concretely, before starting executing the data processing by the data processing system, the processor 2 sets the content of the link map table 12, basing on the content of the processing by the data processing system and the implementations and structure of the special purpose function unit α.

According to the link map table 12 set by the processor 2, the selector δ practically connects the special purpose function unit α as the source of data transfer to the special purpose function unit α as the destination of the data transfer, by the data bus ε.

In the following, this point is described referring to an example. It is assumed that the processor 2 executes a series of instructions for setting a value to the address in the link map table 12, allocated in the memory space of the processor 2. It is further assumed that for example, as shown in FIG. 8, the processor 2 sets the destination of data transfer for the special purpose function unit α1 to the special purpose function unit αm, the destination of data transfer for the special purpose function unit am to the special purpose function unit α1, the destination of data transfer for the special purpose function unit αm to the special purpose function unit αN, and the destination of data transfer for the special purpose function unit αN to the special purpose function unit am.

Such a setup of the link map table 12, for example, can be performed by the processor 2, according to the instruction of an external controller (not shown) to control the data processing system, or according to an initializing program, stalled previously in this data processing system and used at the time of the system start-up.

The selector δ of the special purpose function unit a uses, as control information, the information of the source of data transfer and the destination of data transfer, which are set on the link map table 12.

According to the link map table 12, the selector δm of the special purpose function unit am selects the data bus ε1, and practically connects the local data memory γ1 of the special purpose function unit α1 and the local data memory γm of the special purpose function unit αm.

By this connection, the data stored in the local data memory γ1 of the special purpose function unit α1 is transferred to the local data memory γm of the special purpose function unit αm.

The special purpose calculating circuit βm of the special purpose function unit am executes the processing of calculating for the data stored in the local data memory γm, and then stores the result into the local data memory γm.

According to the link map table 12, the selector δN of the special purpose function unit αN selects the data bus εm, and then practically connects the local data memory γm of the special purpose function unit am with the local data memory γN of the special purpose function unit αN.

By this connection, the data stored in the local data memory γm of the special purpose function unit αm is transferred to the local data memory γN of the special purpose function unit αN.

The special purpose calculating circuit βN of the special purpose function unit αN executes the processing of calculating for the data stored in the local data memory γN, and then stores the result into the local data memory γN.

As described above, in the present embodiment the data buses ε0˜εN are provided to connect the special purpose function units α0˜αN operating under wired logic control.

Therefore, the data transfer among the special purpose function units α0˜αN can be performed via the data buses ε0˜εN.

For this reason, the frequency of the data transfer via the data bus 4 can be suppressed. Therefore, when a series of processing is performed by the processor 2 operating under the program control and by the special purpose function units α0˜αN, the reduction of the waiting time for the data transfer can be realized.

As a result, the improvement of efficiency for data processing can be realized, not depending on the number of the special purpose function units α0˜αN.

The flexibility of the data processing by the processor 2, operating under program control, and the reduction of electric power consumption by the special purpose function units α0˜αN, operating under wired logic control, can be maintained.

In the present embodiment, the bilateral data transfer between the special purpose function unit α and the other special purpose function unit α can be performed by using the data bus ε.

Therefore, the result of one special purpose function unit α can be processed by the other special purpose function unit a, and the result of the other special purpose function unit a can be processed by one special purpose function unit a.

In the present embodiment, the data transfer in an arbitrary direction among arbitrary special purpose function units α can be performed, according to the function of the special purpose calculating circuit β in the special purpose function unit a via the data bus ε.

By providing the data bus ε and making it possible to transfer data in an arbitrary direction among arbitrary special purpose function units α possible, a various data processing can be carried out, by only changing the special purpose function unit α. Changing the hardware structure for the data bus ε or for the processor 2 that controls the data transfer with the data bus ε is not necessary for this processing.

In the present embodiment when the processor 2 controls the data transfer via the data bus ε, a special circuit to control the data transfer via the data bus ε is unnecessary, and the reduction in the area of circuits to be packaged can be realize.

Furthermore, it is possible for the processor 2 to program-control the data transfer via the data bus ε among the special purpose function units α. As a result, the data transfer between the special purpose function units α can be performed without any restrictions.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A data processing system, comprising:
a first data processing unit operable to perform data processing under program control;
a plurality of second data processing units, each of said second data processing units being operable to perform data processing under wired logic control;
a storage unit operable to store data;
a first data transfer unit operable to connect said first data processing unit and said plurality of second data processing units, via said storage unit; and
a second data transfer unit operable to connect said plurality of second data processing units.

2. The data processing system according to claim 1,
wherein said second data transfer unit is operable to perform a bilateral data transfer between one of said plurality of second data processing units and another of said plurality of second data processing units.

3. The data processing system according to claim 1,
wherein said second data transfer unit is operable to perform a unilateral data transfer between one of said plurality of second data processing units and another of said plurality of second data processing units.

4. The data processing system according to claim 1,
wherein said second data transfer unit is operable to connect one of said plurality of second data processing units and another of said plurality of second data processing units in one-to-one correspondence.

5. The data processing system according to claim 1,
wherein said second data transfer unit is operable to connect one of said plurality of second data processing units and some of the other of said plurality of second data processing units in one-to-many correspondence.

6. The data processing system according to claim 1,
wherein said second data transfer unit is operable to connect said plurality of second data processing units.

7. The data processing system according to claim 1,
wherein said second data transfer unit is operable to connect said plurality of second data processing units and to perform a unilateral data transfer from a prescribed unit of said plurality of second data processing units to a plurality of other units of said plurality of second data processing units.

8. The data processing system according to claim 1, further comprising
a third data transfer unit operable to connect said first data processing unit and said second data processing unit.

9. The data processing system according to claim 4, wherein each of said plurality of second data processing units comprises
a calculating unit, and
a fourth data transfer unit operable to connect said calculating unit and said second data transfer unit.

10. The data processing system according to claim 1,
wherein said first data processing unit is operable to control data transfer via said second data transfer unit.

11. The data processing system according to claim 8,
wherein said first data processing unit is operable to control data transfer via said third data transfer unit.

12. The data processing system according to claim 1, further comprising
a first data transfer control unit operable to control data transfer via said second data transfer unit.

13. The data processing system according to claim 8, further comprising
a second data transfer control unit operable to control data transfer via said third data transfer unit.

14. The data processing system according to claim 1,
wherein said second data processing unit is operable to perform processing of encoding.

15. The data processing system according to claim 1,
wherein said second data processing unit is operable to perform processing of decoding.
